(19) United States
(12) Patent Application Publication
(10) Pub. No.: US 2025/0225680 A1
(43) Pub. Date: Jul. 10, 2025

(54) SYSTEM AND METHOD FOR GEOMETRY POINT CLOUD CODING

(71) Applicant: GUANGDONG OPPO MOBILE TELECOMMUNICATIONS CORP., LTD., Dongguan, Guangdong (CN)

(72) Inventors: Yue YU, PALO ALTO, CA (US); Haoping YU, PALO ALTO, CA (US)

(21) Appl. No.: 18/869,095

(22) PCT Filed: Jun. 21, 2023
(86) PCT No.: PCT/US2023/025841

§ 371 Date: Nov. 25, 2024

Related U.S. Application Data
(60) Provisional application No. 63/366,904, filed on Jun. 23, 2022.

(51) Int. Cl. G06T 9/00; H04N 19/70

(52) U.S. Cl. CPC G06T 9/001; H04N 19/70

(57) ABSTRACT

According to one aspect of the present disclosure, a method for decoding a point cloud that is represented in a one-dimension (ID) array that includes a set of points is provided. The method may include identifying, by at least one processor, a maximum number of transform coefficients used to predict an attribute value of a point in the set of points. The method may include decoding, by the at least one processor, a bitstream to identify the maximum number of transform coefficients based on a logarithmic format minus a fixed integer.

### CROSS-REFERENCE TO RELATED APPLICATIONS

This application is a national phase entry under 35 USC 371 of International Patent Application No. PCT/US2023/025841, filed on Jun. 21, 2023, which claims the benefit of priority to U.S. Provisional Application No. 63/366,904, filed Jun. 23, 2022, entitled “GEOMETRY POINT CLOUD CODING,” which are incorporated by reference herein in their entirety.

### TECHNICAL FIELD

The present disclosure relates to the point cloud coding field, and more particularly, to a system and method for geometry point cloud coding.

### BACKGROUND

Point clouds are one of the major three-dimension (3D) data representations, which provide, in addition to spatial coordinates, attributes associated with the points in a 3D world. Point clouds in their raw format require a huge amount of memory for storage or bandwidth for transmission. Furthermore, the emergence of higher resolution point cloud capture technology imposes, in turn, even a higher requirement on the size of point clouds. In order to make point clouds usable, compression is necessary. Two compression technologies have been proposed for point cloud compression/coding (PCC) standardization activities: video-based PCC (V-PCC) and geometry-based PCC (G-PCC). V-PCC approach is based on 3D to two-dimensional (2D) projections, while G-PCC, on the contrary, encodes the content directly in 3D space. In order to achieve that, G-PCC utilizes data structures, such as an octree that describes the point locations in 3D space.

### SUMMARY

According to one aspect of the present disclosure, a method for decoding a point cloud that is represented in a one-dimension (1D) array that includes a set of points is provided. The method may include identifying, by at least one processor, a maximum number of transform coefficients used to predict an attribute value of a point in the set of points. The method may include decoding, by the at least one processor, a bitstream to identify the maximum number of transform coefficients based on a logarithmic format minus a fixed integer.

According to another aspect of the present disclosure, a system for decoding a point cloud that is represented in a 1D array that includes a set of points is provided. The system may include at least one processor and memory storing instructions. The memory storing instructions, which when executed by the at least one processor, may cause the at least one processor to identify a maximum number of transform coefficients used to predict an attribute value of a point in the set of points. The memory storing instructions, which when executed by the at least one processor, may cause the at least one processor to decode a bitstream to identify the maximum number of transform coefficients based on a logarithmic format minus a fixed integer.

According to a further aspect of the present disclosure, a method for encoding a point cloud that is represented in a 1D array including a set of points is provided. The method may include identifying, by at least one processor, a maximum number of transform coefficients used to predict an attribute value of a point in the set of points. The method may include encoding, by the at least one processor, a bitstream to indicate the maximum number of transform coefficients based on a logarithmic format minus a fixed integer.

According to a further aspect of the present disclosure, a system for encoding a point cloud that is represented in a 1D array including a set of points is provided. The system may include at least one processor and memory storing instructions. The memory storing instructions, which when executed by at least one processor, may cause the at least one processor to identify a maximum number of transform coefficients used to predict an attribute value of a point in the set of points. The memory storing instructions, which when executed by at least one processor, may cause the at least one processor to encode a bitstream to indicate the maximum number of transform coefficients based on a logarithmic format minus a fixed integer.

According to yet another aspect of the present disclosure, a method for decoding a point cloud that is represented in a 1D array including a set of points is provided. The method may include identifying, by at least one processor, a maximum zero-run length associated with a plurality of attribute values associated with one or more points in the set of points. In response to a coded zero-run length being less than or equal to the maximum zero-run length, the method may include decoding, by the at least one processor, a bitstream in a single-loop process based on the zero-run length. In response to the coded zero-run length being greater than the maximum zero-run length, the method may include decoding, by the at least one processor, the bitstream based on the maximum zero-run length and the coded zero-run length in a multi-loop process.

According to yet a further aspect of the present disclosure, a system for decoding a point cloud that is represented in a 1D array including a set of points is provided. The system may include at least one processor and memory storing instructions. The memory storing instructions, which when executed by the at least one processor, may cause the at least one processor to identify a maximum zero-run length associated with a plurality of attribute values associated with one or more points in the set of points. In response to a coded zero-run length being less than or equal to the maximum zero-run length, the memory storing instructions, which when executed by the at least one processor, may cause the at least one processor to decode a bitstream in a single-loop process based on the zero-run length. In response to the coded zero-run length being greater than the maximum zero-run length, the memory storing instructions, which when executed by the at least one processor, may cause the at least one processor to decode the bitstream based on the maximum zero-run length and the coded zero-run length in a multi-loop process.

According to yet a further aspect of the present disclosure, a method for encoding a point cloud that is represented in a 1D array including a set of points is provided. The method may include identifying, by at least one processor, a maximum zero-run length associated with a plurality of attribute values associated with one or more points in the set of points. In response to a coded zero-run length being less than or equal to the maximum zero-run length, the method may include encoding, by the at least one processor, a bitstream in a single-loop process based on the zero-run length. The method further includes: in response to the coded zero-run length being greater than the maximum zero-run length, encoding, by the at least one processor, the bitstream based on the maximum zero-run length and the coded zero-run length in a multi-loop process.

According to still a further aspect of the present disclosure, a system for encoding a point cloud that is represented in a 1D array including a set of points is provided. The system may include at least one processor and memory storing instructions. The memory storing instructions, which when executed by the at least one processor, may cause the at least one processor to identify a maximum zero-run length associated with a plurality of attribute values associated with one or more points in the set of points. In response to a coded zero-run length being less than or equal to the maximum zero-run length, the memory storing instructions, which when executed by the at least one processor, may cause the at least one processor to encode a bitstream in a single-loop process based on the zero-run length. In response to the coded zero-run length being greater than the maximum zero-run length, the memory storing instructions, which when executed by the at least one processor, may cause the at least one processor to encode the bitstream based on the maximum zero-run length and the coded zero-run length in a multi-loop process.

These illustrative embodiments are mentioned not to limit or define the present disclosure, but to provide examples to aid understanding thereof. Additional embodiments are described in the Detailed Description, and further description is provided there.

### BRIEF DESCRIPTION OF THE DRAWINGS

The accompanying drawings, which are incorporated herein and form a part of the specification, illustrate embodiments of the present disclosure and, together with the description, further serve to explain the principles of the present disclosure and to enable a person skilled in the pertinent art to make and use the present disclosure.

FIG. 1 illustrates a block diagram of an exemplary encoding system, according to some embodiments of the present disclosure.

FIG. 2 illustrates a block diagram of an exemplary decoding system, according to some embodiments of the present disclosure.

FIG. 3 illustrates a detailed block diagram of an exemplary encoder in the encoding system in FIG. 1, according to some embodiments of the present disclosure.

FIG. 4 illustrates a detailed block diagram of an exemplary decoder in the decoding system in FIG. 2, according to some embodiments of the present disclosure.

FIGS. 5A and 5B illustrate an exemplary octree structure of G-PCC and the corresponding digital representation, respectively, according to some embodiments of the present disclosure.

FIG. 6 illustrates an exemplary structure of cube and the relationship with neighboring cubes in an octree structure of G-PCC, according to some embodiments of the present disclosure.

FIG. 7 illustrates an exemplary 1D array of points representing a point cloud, a set of candidate points, and a set of prediction points, according to some embodiments of the present disclosure.

FIG. 8 illustrates an exemplary hierarchy of parameter sets of G-PCC, according to some embodiments of the present disclosure.

FIG. 9 illustrates a flow chart of an exemplary method for encoding a point cloud, according to some embodiments of the present disclosure.

FIG. 10 illustrates a flow chart of an exemplary method for decoding a point cloud, according to some embodiments of the present disclosure.

FIG. 11 illustrates a flow chart of another exemplary method for encoding a point cloud, according to some embodiments of the present disclosure.

FIG. 12 illustrates a flow chart of another exemplary method for decoding a point cloud, according to some embodiments of the present disclosure.

Embodiments of the present disclosure will be described with reference to the accompanying drawings.

### DETAILED DESCRIPTION

Although some configurations and arrangements are discussed, it should be understood that this is done for illustrative purposes only. A person skilled in the pertinent art will recognize that other configurations and arrangements can be used without departing from the spirit and scope of the present disclosure. It will be apparent to a person skilled in the pertinent art that the present disclosure can also be employed in a variety of other applications.

It is noted that references in the specification to “one embodiment,” “an embodiment,” “an example embodiment,” “some embodiments,” “certain embodiments,” etc., indicate that the embodiment described may include a particular feature, structure, or characteristic, but every embodiment may not necessarily include the particular feature, structure, or characteristic. Moreover, such phrases do not necessarily refer to the same embodiment. Further, when a particular feature, structure, or characteristic is described in connection with an embodiment, it would be within the knowledge of a person skilled in the pertinent art to effect such feature, structure, or characteristic in connection with other embodiments whether or not explicitly described.

In general, terminology may be understood at least in part from usage in context. For example, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

Various aspects of point cloud coding systems will now be described with reference to various apparatus and methods. These apparatus and methods will be described in the following detailed description and illustrated in the accompanying drawings by various modules, components, circuits, steps, operations, processes, algorithms, etc. (collectively referred to as “elements”). These elements may be implemented using electronic hardware, firmware, computer software, or any combination thereof. Whether such elements are implemented as hardware, firmware, or software depends upon the particular application and design constraints imposed on the overall system. The techniques described herein may be used for various point cloud coding applications. As described herein, point cloud coding includes both encoding and decoding a point cloud.

A point cloud is composed of a collection of points in a 3D space. Each point in the 3D space is associated with a geometry position together with the associated attribute information (e.g., color, reflectance, intensity, classification, etc.). In order to compress the point cloud data efficiently, the geometry of a point cloud can be compressed first, and then the corresponding attributes, including color or reflectance, can be compressed based upon the geometry information according to a point cloud coding technique, such as G-PCC. G-PCC has been widely used in virtual reality/augmented reality (VR/AR), telecommunication, autonomous vehicle, etc., for entertainment and industrial applications, e.g., light detection and ranging (LiDAR) sweep compression for automotive or robotics and high-definition (HD) map for navigation. Moving Picture Experts Group (MPEG) released the first version G-PCC standard, and Audio Video Coding Standard (AVS) is also developing a G-PCC standard.

The existing G-PCC standards, however, cannot work well for a wide range of PCC inputs for many different applications. For example, besides the representation of levels (or coefficients in some cases), the representation of other information (e.g., parameters) used for G-PCC may be coded in the forms of syntax elements in the bitstream as well. Since G-PCC is organized in different levels by dividing a collection of points into different pieces (e.g., sequence, slices, etc.) associated with different properties (e.g., geometry, attributes, etc.), the parameter sets are also arranged in different levels (e.g., sequence-level, property-level, slice-level, etc.), for example, in the different headers. Moreover, multiple condition checks may be required for parsing some syntax elements in G-PCC, which further increases the complexity of organizing and parsing the representation of syntax elements.

To improve the flexibility and generality of point cloud coding, the present disclosure provides various novel schemes of syntax element representation and organization, which are compatible with any suitable G-PCC standards, including, but not limited to, AVS G-PCC standards and MPEG G-PCC standards.

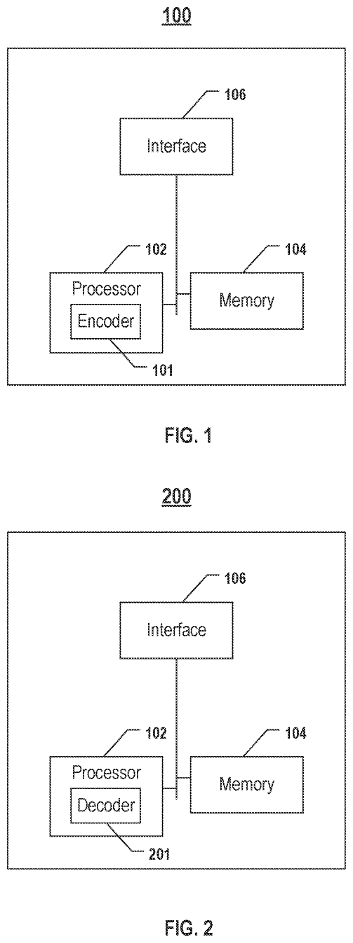

FIG. 1 illustrates a block diagram of an exemplary encoding system 100, according to some embodiments of the present disclosure. FIG. 2 illustrates a block diagram of an exemplary decoding system 200, according to some embodiments of the present disclosure. Each system 100 or 200 may be applied or integrated into various systems and apparatuses capable of data processing, such as computers and wireless communication devices. For example, system 100 or 200 may be the entirety or part of a mobile phone, a desktop computer, a laptop computer, a tablet, a vehicle computer, a gaming console, a printer, a positioning device, a wearable electronic device, a smart sensor, a virtual reality (VR) device, an argument reality (AR) device, or any other suitable electronic devices having data processing capability. As shown in FIGS. 1 and 2, system 100 or 200 may include a processor 102, a memory 104, and an interface 106. These components are shown as connected one to another by a bus, but other connection types are also permitted. It is understood that system 100 or 200 may include any other suitable components for performing functions described here.

Processor 102 may include microprocessors, such as graphic processing unit (GPU), image signal processor (ISP), central processing unit (CPU), digital signal processor (DSP), tensor processing unit (TPU), vision processing unit (VPU), neural processing unit (NPU), synergistic processing unit (SPU), or physics processing unit (PPU), microcontroller units (MCUs), application-specific integrated circuits (ASICs), field-programmable gate arrays (FPGAs), programmable logic devices (PLDs), state machines, gated logic, discrete hardware circuits, and other suitable hardware configured to perform the various functions described throughout the present disclosure. Although only one processor is shown in FIGS. 1 and 2, it is understood that multiple processors can be included. Processor 102 may be a hardware device having one or more processing cores. Processor 102 may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. Software can include computer instructions written in an interpreted language, a compiled language, or machine code. Other techniques for instructing hardware are also permitted under the broad category of software.

Memory 104 can broadly include both memory (a.k.a, primary/system memory) and storage (a.k.a. secondary memory). For example, memory 104 may include random-access memory (RAM), read-only memory (ROM), static RAM (SRAM), dynamic RAM (DRAM), ferro-electric RAM (FRAM), electrically erasable programmable ROM (EEPROM), compact disc read-only memory (CD-ROM) or other optical disk storage, hard disk drive (HDD), such as magnetic disk storage or other magnetic storage devices, Flash drive, solid-state drive (SSD), or any other medium that can be used to carry or store desired program code in the form of instructions that can be accessed and executed by processor 102. Broadly, memory 104 may be embodied by any computer-readable medium, such as a non-transitory computer-readable medium. Although only one memory is shown in FIGS. 1 and 2, it is understood that multiple memories can be included.

Interface 106 can broadly include a data interface and a communication interface that is configured to receive and transmit a signal in a process of receiving and transmitting information with other external network elements. For example, interface 106 may include input/output (I/O) devices and wired or wireless transceivers. Although only one memory is shown in FIGS. 1 and 2, it is understood that multiple interfaces can be included.

Processor 102, memory 104, and interface 106 may be implemented in various forms in system 100 or 200 for performing point cloud coding functions. In some embodiments, processor 102, memory 104, and interface 106 of system 100 or 200 are implemented (e.g., integrated) on one or more system-on-chips (SoCs). In one example, processor 102, memory 104, and interface 106 may be integrated on an application processor (AP) SoC that handles application processing in an operating system (OS) environment, including running point cloud encoding and decoding applications. In another example, processor 102, memory 104, and interface 106 may be integrated on a specialized processor chip for point cloud coding, such as a GPU or ISP chip dedicated to graphic processing in a real-time operating system (RTOS).

As shown in FIG. 1, in encoding system 100, processor 102 may include one or more modules, such as an encoder 101. Although FIG. 1 shows that encoder 101 is within one processor 102, it is understood that encoder 101 may include one or more sub-modules that can be implemented on different processors located closely or remotely with each other. Encoder 101 (and any corresponding sub-modules or sub-units) can be hardware units (e.g., portions of an integrated circuit) of processor 102 designed for use with other components or software units implemented by processor 102 through executing at least part of a program, i.e., instructions. The instructions of the program may be stored on a computer-readable medium, such as memory 104, and when executed by processor 102, it may perform a process having one or more functions related to point cloud encoding, such as voxelization, transformation, quantization, arithmetic encoding, etc., as described below in detail.

Similarly, as shown in FIG. 2, in decoding system 200, processor 102 may include one or more modules, such as a decoder 201. Although FIG. 2 shows that decoder 201 is within one processor 102, it is understood that decoder 201 may include one or more sub-modules that can be implemented on different processors located closely or remotely with each other. Decoder 201 (and any corresponding sub-modules or sub-units) can be hardware units (e.g., portions of an integrated circuit) of processor 102 designed for use with other components or software units implemented by processor 102 through executing at least part of a program, i.e., instructions. The instructions of the program may be stored on a computer-readable medium, such as memory 104, and when executed by processor 102, it may perform a process having one or more functions related to point cloud decoding, such as arithmetic decoding, dequantization, inverse transformation, reconstruction, synthesis, as described below in detail.

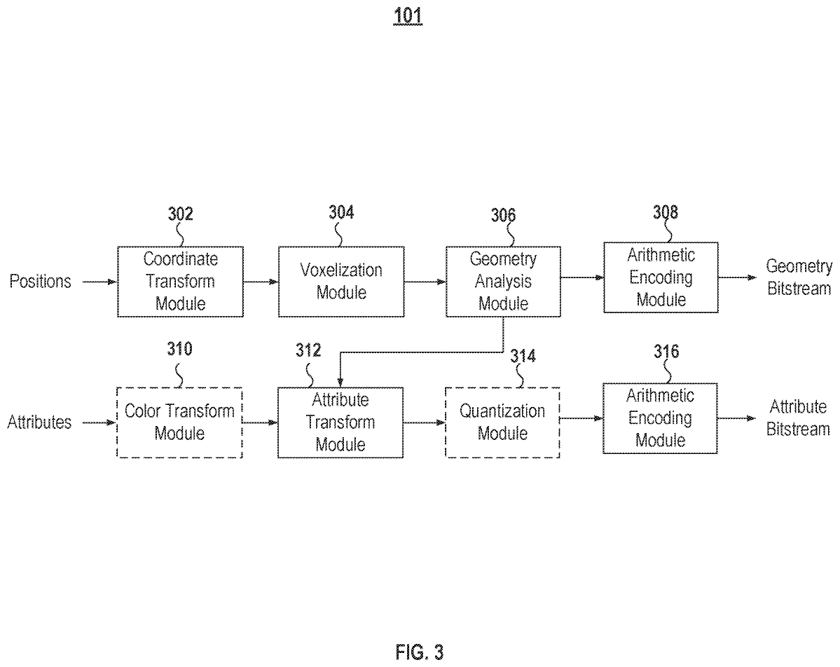

FIG. 3 illustrates a detailed block diagram of exemplary encoder 101 in encoding system 100 in FIG. 1, according to some embodiments of the present disclosure. As shown in FIG. 3, encoder 101 may include a coordinate transform module 302, a voxelization module 304, a geometry analysis module 306, and an arithmetic encoding module 308, together configured to encode positions associated with points of a point cloud into a geometry bitstream (i.e., geometry encoding). As shown in FIG. 3, encoder 101 may also include a color transform module 310, an attribute transform module 312, a quantization module 314, and an arithmetic encoding module 316, together configured to encode attributes associated with points of a point cloud into an attribute bitstream (i.e., attribute encoding). It is understood that each of the elements shown in FIG. 3 is independently shown to represent characteristic functions different from each other in a point cloud encoder, and it does not mean that each component is formed by the configuration unit of separate hardware or single software. That is, each element is included to be listed as an element for convenience of explanation, and at least two of the elements may be combined to form a single element, or one element may be divided into a plurality of elements to perform a function. It is also understood that some of the elements are not necessary elements that perform functions described in the present disclosure but instead may be optional elements for improving performance. It is further understood that these elements may be implemented using electronic hardware, firmware, computer software, or any combination thereof. Whether such elements are implemented as hardware, firmware, or software depends upon the particular application and design constraints imposed on encoder 101. It is still further understood that the modules shown in FIG. 3 are for illustrative purposes only, and in some examples, different modules may be included in encoder 101 for point cloud encoding.

As shown in FIG. 3, geometry positions and attributes associated with points may be encoded separately. A point cloud may be a collection of points with positions Xₖ=(xₖ, yₖ, zₖ), k=1, . . . , K, where K is the number of points in the point cloud, and attributes Aₖ=(A₁ₖ, A₂ₖ, . . . , A_{Dk}), k=1, . . . , K, where D is the number of attributes for each point. In some embodiments, attribute coding depends on decoded geometry. As a consequence, point cloud positions may be coded first. Since geometry positions may be represented by floating-point numbers in an original coordinate system, coordinate transform module 302 and a voxelization module 304 may be configured to perform a coordinate transformation followed by voxelization that quantizes and removes duplicate points. The process of position quantization, duplicate point removal, and assignment of attributes to the remaining points is called voxelization. The voxelized point cloud may be represented using, for example, an octree structure in a lossless manner. Geometry analysis module 306 may be configured to perform geometry analysis using, for example, the octree or trisoup scheme. Arithmetic encoding module 308 may be configured to arithmetically encode the resulting structure from geometry analysis module 306 into the geometry bitstream.

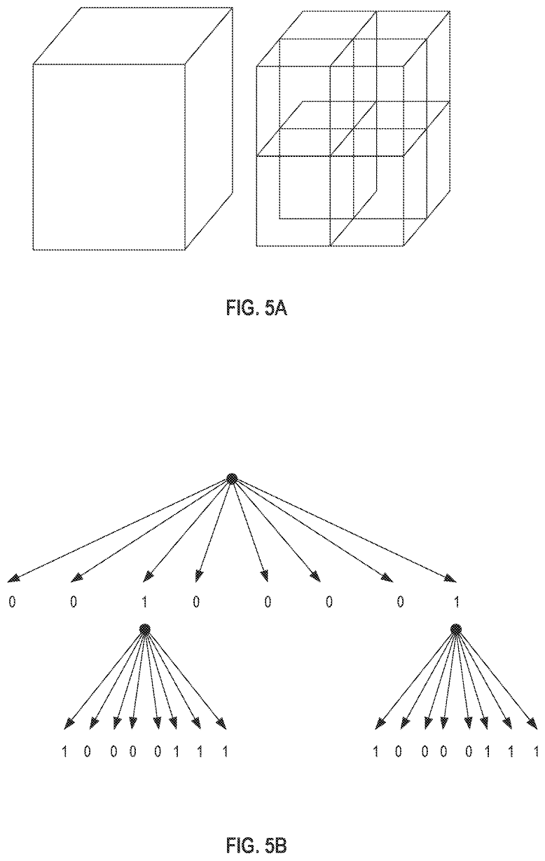

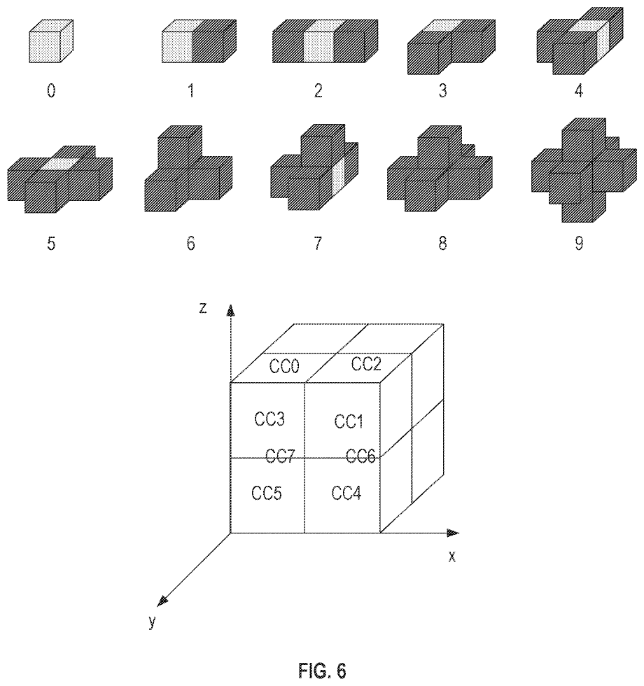

In some embodiments, geometry analysis module 306 is configured to perform geometry analysis using the octree scheme. Under the octree scheme, a cubical axis-aligned bounding box B may be defined by the two extreme points (0,0,0) and (2^{d},2^{d},2^{d}) where d is the maximum size of the given point cloud along the x, y, or z direction. All point cloud points may be included in this defined cube. A cube may be divided into eight sub-cubes, which creates the octree structure allowing one parent to have 8 children, and an octree structure may then be built by recursively subdividing sub-cubes, as shown in FIG. 5A. As shown in FIG. 5B, an 8-bit code may be generated by associating a 1-bit value with each sub-cube to indicate whether it contains points (i.e., full and has value 1) or not (i.e., empty and has value 0). Only full sub-cubes with a size greater than 1 (i.e., non-voxels) may be further subdivided. The geometry information (x, y, z) for one position may be represented by this defined octree structure. Since points may be duplicated, multiple points may be mapped to the same sub-cube of size 1 (i.e., the same voxel). In order to handle such a situation, the number of points for each sub-cube of dimension 1 is also arithmetically encoded. By construction of the octree, a current cube associated with a current node may be surrounded by six cubes of the same depth sharing a face with it. Depending on the location of the current cube, one cube may have up to six same-sized cubes to share one face, as shown in FIG. 6. In addition, the current cube may also have some neighboring cubes which share lines or points with the current cube.

Referring back to FIG. 3, as to attribute encoding, optionally, color transform module 310 may be configured to convert red/green/blue (RGB) color attributes of each point to YCbCr color attributes if the attributes include color. Attribute transform module 312 may be configured to perform attribute transformation based on the results from geometry analysis module 306 (e.g., using the octree scheme), including but not limited to, the region adaptive hierarchical transform (RAHT), interpolation-based hierarchical nearest-neighbor prediction (predicting transform), and interpolation-based hierarchical nearest-neighbor prediction with an update/lifting step (lifting transform). Optionally, quantization module 314 may be configured to quantize the transformed coefficients of attributes from attribute transform module 312 to generate quantization levels of the attributes associated with each point to reduce the dynamic range. Arithmetic encoding module 316 may be configured to arithmetically encode the resulting transformed coefficients of attributes associated with each point or the quantization levels thereof into the attribute bitstream.

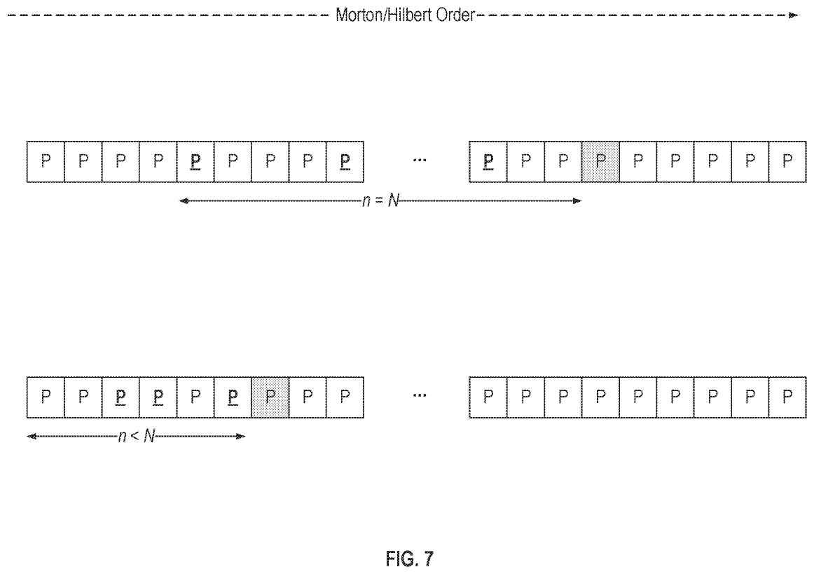

In some embodiments, a prediction may be formed from neighboring coded attributes, for example, in predicting transform and lifting transform by attribute transform module 312. Then, the difference between the current attribute and the prediction may be coded. According to some aspects of the present disclosure, in the AVS G-PCC standard, after the geometry positions are coded, a Morton code or Hilbert code may be used to convert a point cloud in a 3D space (e.g., a point cloud cube) into a 1D array, as shown in FIG. 7. Each position in the cube will have a corresponding Morton or Hilbert code, but some positions may not have any corresponding point cloud attribute. In other words, some positions may be empty. The attribute coding may follow the predefined Morton order or Hilbert order. A predictor may be generated from the previous coded points in the 1D array following the Morton order or Hilbert order. The attribute difference between the current point and its prediction points may be encoded into the bitstream. In some embodiments, the point cloud in the 3D space (e.g., a point cloud cube) is converted into a 1D array without any pre-defined order, but instead in its native input order, for example, the order in which the point cloud data is collected. That is, in some examples, the attribute coding may follow the native input order of the point cloud, instead of the predefined Morton order or Hilbert order. In other words, the order followed by the points in the 1D array may be either a Morton order, a Hilbert order, or the native input order.

As shown in FIG. 7, to reduce the memory usage, some predefined numbers may be specified to limit the number of neighboring points that can be used in generating the prediction. For example, only at most M points among previous at most N consecutively coded points may be used for coding the current attribute. That is, a set of n candidate points may be used as the candidates to select a set of m prediction points (m≤n) for predicting the current point in attribute coding. The number n of candidate points in the set is equal to or smaller than the maximum number N of candidate points (n≤N), and the number m of prediction points in the set is equal to or smaller than the maximum number M of prediction points (m≤M). As shown in FIG. 7, if the number of neighboring points prior to the current point in the 1D array following the Morton order, the Hilbert order, or the native input order is larger than the maximum number N of candidate points, then the number n of candidate points in the set of candidate points for the current point (shaded in grey) is equal to the maximum number N; if the number of neighboring points prior to the current point in the 1D array following the Morton order, the Hilbert order, or the native input order is less than or equal to the maximum number N of candidate points, then the number n of candidate points in the set of candidate points for the current point (shaded in grey) is smaller to the maximum number N, then all the neighboring points prior to the current point are used as the set of candidate points for the current point. In FIG. 7, the maximum number M of prediction points is set to be 3, and a set of 3 prediction points (P, bolded and underlined) may be selected from the set of n candidate points, for example, based on the positions associated with the n candidate points and the current points (e.g., the distances between each candidate point and the current point).

In some embodiments, M and N are set as a fixed number of 3 and 128, respectively. If more than 128 points before the current point are already coded, only 3 out of the previous 128 neighboring points could be used to form attribute predictors (prediction points) according to a predefined order. If there are less than 128 coded points before the current point, all coded points before the current point will be used as candidate points to find the prediction points. Among the previous up to 128 candidate points, up to 3 prediction points are selected, which have the closest “distance” (e.g., Euclidean distance) between these candidate points and the current point. The Euclidean distance d as one example may be defined as follows, while other distance metrics can also be used in other examples:

$$d = \vert x 1 - x 2 \vert + \vert y 1 - y 2 \vert + \vert z 1 - z 2 \vert , \qquad ( 1 )$$

where (x1,y1,z1) and (x2,y2,z2) are the coordinates of the current point and the candidate point along the Morton order, the Hilbert order, or the native input order, respectively. Once m prediction points (e.g., the 3 closest candidate points) have been selected, a weighted attribute average from these m points may be formed as the predictor to code the attribute of the current point, according to some embodiments. It is understood that in some examples, the prediction points may be selected from the candidate points that are in the cubes sharing the same face/line/point with the current point cloud.

Since the set of n candidate points needs to be stored in the memory and traversed in order to select the set of m prediction points for coding the attributes associated with the current position, the maximum number M of candidate points is introduced to limit the size of memory and amount of computation resources that may be occupied by the candidate points storage and searching.

According to some aspects of the present disclosure, the difference in attribute values between the current point and its predictor may be referred to as a “residual.” Depending on the application, PCC can be either lossless or lossy. Hence, the residual may or may not be further transformed, and the residual may or may not be quantized by using the predefined quantization process. According to the present disclosure, the residual without or with quantization may be referred to as a “level,” which is a signed integer (e.g., a positive or negative integer value) coded into the bitstream.

There are three color attributes for each point, which come from the three color components. If the levels for all the three color components are zeros, this point is called a zero-level point. Otherwise, if there is at least one non-zero level for one color component with the point, this point is called a non-zero level point. The number of consecutive zero-level points is referred to as a “zero-run length.” The zero-run length values and levels for non-zero level points are coded into the bitstream. More specifically, before coding the first point, encoder 101 may set the zero-run length counter as zero.

Starting from the first point along the predefined coding order, the residuals between the three color predictors and their corresponding color attributes for the current point can be obtained. Then, the corresponding levels for the three components of the current point can also be obtained. If the current point is a zero-level point, encoder 101 may increase the zero-run length value by one, and the process proceeds to the next point. If the current point is a non-zero level point, the zero-run length value will be coded first, and then the three color levels for this non-zero level point will be coded right after. After the level coding of a non-zero level point, the zero-run length value will be reset to zero, and the process proceeds to the next point till finishing all points. On the decoding side, decoder 201 may decode the zero-run length value, and the three color levels corresponding to the number of zero-run length points are set as zero. Then, the levels for the non-zero level point are decoded, and then the next zero-run length value is decoded. This process continues until all points are decoded. Tables 1 and 2 illustrate example syntax elements used for color-residual coding and color-level coding, respectively.

TABLE 1
Syntax elements for color-residual coding

| | Descriptor |
|---|---|
| color_residual_coding( ) { | |
| color_first_comp_zero | ae(v) |
| if (!color_first_comp_zero) { | |
| color_component[0] = (2*coded_level_sign −1) | |
| *\|coded_level_coding (true) + 1\| | |
| color_component[1] = coded_level_coding (false) | |
| color_component[2] = coded_level_coding (false) | |
| } else { | |
| color_component[0] = 0 | |
| color_second_comp_zero | ae(v) |
| If (!color_second_comp_zero) { | |
| color_component[1] = (2*coded_level_sign −1) | |
| *\|coded_level_coding (true) + 1\| | |
| color_component[2] = coded_level_coding (false) | |
| else { | |
| color_component[1] = 0 | |
| color_component[2] = (2*coded_level_sign −1) | |
| *\|coded_level_coding (true) + 1\| | |
| } | |
| } | |
| } | |

TABLE 2
Syntax elements for color-level coding

| | Descriptor |
|---|---|
| coded_level_coding (isComponentNoneZero) { | |
| coded_level_equal_zero | ae(v) |
| if (!coded_level_equal_zero) | |
| coded_level_sign | ae(v) |
| if (!coded_level_equal_zero) { | |
| coded_level_sign | ae(v) |
| coded_level_gt1 | ae(v) |
| if (coded_level_gt1) { | |
| coded_level_minus2_parity | ae(v) |
| coded_level_minus2_div2_gt0 | ae(v) |
| if (coded_level_minus2_div2_gt0) | |
| coded_level_minu2_div2_minus1 | ae(v) |
| } | |
| } | |

}

For a non-zero level point, there is at least one non-zero level among the three components. The values of the three color-components are coded in the color_residual_coding( ) syntax element. Several one-bit flags plus the remainder of the absolute level may be coded to represent levels of the three color-components. The absolute level or absolute level of color residual minus one may be coded in the function coded_level_coding( ) which is also referred to hereinafter as the “coded level.”

According to some aspects of the present disclosure, a first flag (color_first_comp_zero) is coded to indicate whether the first component of color is zero or not; if the first color-component is zero, a second flag (color_second_comp_zero) is coded to indicate whether the second color-component of color is zero; if the second component of color is zero, the absolute level minus one and the sign of the third component will be coded according to the following coded-level technique.

For instance, a first flag is coded to indicate whether the first color-component of color is zero; if the first color-component is zero, a second flag may be coded to indicate whether the second-color component is zero; if the second component of color is not zero, the absolute level minus one and sign of the second color-component and the absolute level and sign of the third color-component will be coded according to the following coded-level technique.

According to another aspect of the present disclosure, a first flag may be coded to indicate whether the color-first component is zero; if the first color-component is not zero, the absolute level minus one and the sign of the first color-component, as well as the absolute levels and signs of the second and third color-components will be coded according to the following coded-level technique.

For example, the first flag (coded_level_equal_zero) is coded to indicate whether the code-level is zero or not; if the coded level is the absolute level of one color-component minus one, e.g., namely, when the isComponentNoneZero flag is set to “true,” the sign (coded_level_sign) of the level of this color-component will be coded. On the other hand, if the first flag indicates that the coded level is not zero, and if the coded level is the absolute level of one color-component, e.g., when the isComponentNoneZero flag is set to “false,” the sign of the level of this color-component will be coded. The second flag (coded_level_gt1) will be coded to indicate if the coded level is greater than one; if the coded level is greater than one, the parity of the coded level minus two is coded, and the third flag (coded_level_minus2_div2_gt0) will be coded to indicate whether the coded level minus two divided by two is greater than zero; if the coded level minus two divided by two is greater than zero, the coded level minus two divided by two minus one will be coded.

Referring to Tables 1 and 2, a color_first_comp_zero value equal to 0 specifies that the absolute coded level for the first component of color is not zero. A color_first_comp_zero value equal to 1 specifies that the absolute coded level for the first component is zero.

A color_second_comp_zero value equal to 0 specifies that the absolute coded level for the second component of color is not zero. A color_second_comp_zero value equal to 1 specifies that the absolute coded level for the second component is zero.

A coded_level_equal_zero value equal to 0 specifies that the absolute coded level for this component is not zero. A coded_level_equal_zero value equal to 1 specifies that the absolute coded level for this component is zero.

A coded_level_gt1 value equal to 0 specifies that the coded level for this component is one. A coded_level_gt1 value equal to 1 specifies that the coded level for this component is greater than one. When a coded_level_gt1 value is not included in the bitstream, decoder 201 may infer the coded_level_gt1 value is equal to 0.

A coded_level_minus2_parity specifies the parity of the coded level minus two for the current color-component. A coded_level_minus2_parity value equal to 0 specifies that the current coded level minus two is an even number. A coded_level_minus2_parity value equal to 1 specifies that the current coded level minus two is an odd number. When a coded_level_minus2_parity value is not present in the bitstream, decoder 201 may infer that coded_level_minus2_parity value is equal to 0.

A coded_level_minus2_div2_gt0 value equal to 0 specifies that the coded level minus two dividing two is zero. A coded_level_minus2_div2_gt0 value equal to 1 specifies that the coded level minus two divided by two is greater than zero. When a coded_level_minus2_div2_gt0 value is not present in the bitstream, decoder 201 may infer the coded_level_minus2_div2_gt0 value is equal to 0.

A coded_level_minu2_div2_minus1 syntax element specifies the value of the coded level minus two divided by two minus one. When a coded_level_minu2_div2_minus1 syntax is not present in the bitstream, decoder 201 may infer coded_level_minu2_div2_minus1 syntax element is equal to 0.

A coded_level and a coded_level_sign are the return values of function coded_level_coding(isComponentminusOne), which represent the coded level. The coded level may include the absolute level of the color residual or the absolute level of the color residual minus one and the sign of non-zero color residual, as indicated below according to expression (2).

$$coded\_level = ( 2 * coded\_level \_sign - 1 ) * ( coded\_level \_equal \_zero ? 0 : 1 + ( coded\_level \_gt 1 + coded\_level \_minus 2 \_parity + ( coded\_level \text{} \_minus 2 \_div 2 \_gt 0 + coded\_level \_minus 2 \_div 2 \_minus 1 ) << 1 ) . \qquad ( 2 )$$

The residual levels of three color components, e.g., color_component[idx], where idx is an index from 0 to 2, are calculated from color_residual_coding( ).

Moreover, the zero-run length of the reflectance level and the non-zero reflectance-level may be coded into the bitstream. More specifically, before coding the first point, encoder 101 may set the zero-run length counter as zero. Starting from the first point along the predefined coding order, the residuals between the predictors and corresponding original points are obtained. Then, the corresponding reflectance-levels may be obtained. If the current reflectance-level is zero, encoder 101 increases the value of the zero-run length counter by one, and the process proceeds to the next point. If the reflectance-level is not zero, encoder 101 may code the zero-run length, followed by coding the non-zero reflectance-level. After coding a non-zero reflectance level, encoder 101 may reset the zero-run length counter to zero, and the process proceeds to the next point. On the decoding side, decoder 201 may decode the zero-run length, and the reflectance-levels corresponding to the number of zero-run length points are set as zero. Then, decoder 201 may decode the non-zero reflectance level, followed by decoding the next number of zero-run length. This process may continue until all points are decoded.

For a non-zero reflectance-level, if the current point is not a duplicated point, the sign of the reflectance-level is coded with a “residual_sign” syntax element. Then, an “abs_level_minus1_parity” syntax element, which indicates the parity of the absolute level minus one, may be coded by encoder 101. Another syntax element “abs_level_minus1_div2_gt0” may be coded to indicate whether the value of the absolute level minus one divided by two is greater than zero; if abs_level_minus1_div2_gt0 is greater than zero, encoder 101 may encode an “abs_level_minus1_div2_gt1” syntax element to indicate whether the value of the absolute level minus one divided by two is greater than one; if the abs_level_minus1_div2_gt1 syntax element is greater than 1, encoder 101 may encode “abs_level_minu1_div2_minus2” syntax element to indicate the value of the absolute level minus one divided by two minus two. Table 3 shown below illustrates example reflectance-level coding syntax elements.

TABLE 3
Reflectance-level coding syntax elements

| | Descriptor |
|---|---|
| attribute_data_reflectance( ) { | |
| zero_run_length_code(useGolomb) | |
| for( i = 0; i < pointCloudNum; i++ ) { | |
| if (residual_zero_run_length) { | |
| -- residual_zero_run_length | |
| } else { | |
| if ( !isDuplicatePoint) { | |
| residual_sign | ae(1) |
| } | |
| abs_level_minus1_parity | ae(v) |
| abs_level_minus1_div2_gt0 | ae(v) |
| if (abs_level_minus1_div2_gt0) { | |
| abs_level_minus1_div2_gt1 | ae(v) |
| if (abs_level_minus1_div2_gt1) { | |
| abs_level_minul_div2_minus2 | ae(v) |
| } | |
| } | |
| zero_run_length_code(useGolomb) | |
| } | |
| } | |
| termination_bit_one /* equals to 1 */ | ae(v) |
| } | |

Referring to Table 3, the abs_level_minus1_parity syntax element specifies the parity of absolute reflectance level minus one. An abs_level_minus1_parity value equal to 0 may indicate that the absolute reflectance level minus one is an even number; on the other hand, an abs_level_minus1_parity value equal to 1 may indicate that the absolute reflectance level minus one is an odd number.

An abs_level_minus1_div2_gt0 value equal to 0 may indicate that the value of the absolute reflectance level minus one divided by two is zero. An abs_level_minus1_div2_gt0 value equal to 1 may indicate that the value of the absolute reflectance level minus one divided by two is greater than zero. When not present, decoder 201 may infer that the value of abs_level_minus1_div2_got0 is equal to 0.

An abs_level_minus1_div2_gt1 value equal to 0 may indicate that the value of the absolute reflectance level minus one divided by two is one. An abs_level_minus1_div2_gt1 value equal to 1 may indicate that the value of the absolute reflectance level minus one divided by two is greater than one. When not present in the bitstream, decoder 201 may infer the value of the abs_level_minus1_div2_gt1 is equal to 0.

The abs_level_minu1_div2_minus2 syntax value may indicate the value of the absolute reflectance level minus 1 divided by two minus two. When not present, decoder 201 may infer that the value of abs_level_minu1_div2_minus2 is equal to 0.

A residual_sign value equal to 0 may indicate that the sign of the reflectance level is negative; on the other hand, a residual_sign value equal to 1 may indicate that the sign of the reflectance level is positive. When not present in the bitstream, decoder 201 may infer that the value of residual_sign is equal to 1. The reflectance may be calculated according to expression (3).

$$Reflectance = ( 2 * residual\_sign - 1 ) * ( 1 + abs\_level \_minus 1 \_parity + ( abs\_level \_minus 1 \_div 2 \_gt 0 + abs\_level \_minus 1 \_div 2 \_gt 1 + abs\_level \_minus 1 \_div 2 \_minus 2 ) << 1 ) . \qquad ( 3 )$$

Still further, encoder 101 may encode the value of the zero-run length into the bitstream. For example, encoder 101 may encode the first syntax zero_run_length_level_equal_zero (e.g., a first syntax element) into the bitstream to indicate whether the zero-run length is equal to zero; if it is not zero, encoder 101 may encode the zero_run_length_level_equal_one syntax element (e.g., a second syntax element) to indicate whether the zero-run length is equal to one; if it is not one, encoder 101 may encode the zero_run_length_level_equal_two syntax element (e.g., a third syntax element) into the bitstream to indicate whether the zero-run length is equal to two; if it is not two, encoder 101 may encode the zero_run_length_level_minus3_parity syntax element (e.g., fourth syntax element) and the zero_run_length_level_minus3_div2 syntax element (e.g., a fifth syntax element) into the bitstream to indicate the parity of the zero-run length minus three and the value of the zero-run length minus three divided by two, respectively. Examples of the syntax elements used for zero-run length encoding are provided below in Table 4.

TABLE 4
Zero-run length syntax elements

| | Descriptor |
|---|---|
| zero_run_length_code(useGolomb) { | |
| zero_run_length_level_equal_zero | ae(v) |
| if (!zero_run_length_level_equal_zero) { | |
| zero_run_length_level_equal_one | ae(v) |
| if (!zero_run_length_level_equal_one) { | |
| zero_run_length_level_equal_two | ae(v) |
| if (!run_length_level_equal_two) { | |
| zero_run_length_level_minus3_parity | ae(v) |
| zero_run_length_level_minus3_div2 | ae(v) |
| } | |
| } | |
| } | |
| if (useGolomb ) | |
| run_length_LSB | ae(v) |

Referring to Table 4, a zero_run_length_level_minus3_parity specifies the parity of the zero-run length level minus three. zero_run_length_level_minus3_parity equal to 0 specifies that the zero-run length level minus three is an even number. zero_run_length_level_minus3_parity equal to 1 specifies that the zero-run length level minus three is an odd number. When not present, it is inferred to be equal to 0.

A zero_run_length_level_equal_zero value equal to 0 may indicate that the zero-run length level is not zero; on the other hand, a zero_run_length_level_equal_zero value equal to 1 specifies that the zero-run length level is zero.

A zero_run_length_level_equal_one value equal to 0 may indicate that the zero-run length level is not one; on the other hand, a zero_run_length_level_equal_one value equal to 1 specifies that the zero-run length level is one.

A zero_run_length_level_equal_two value equal to 0 may indicate that the zero-run length level is not two; on the other hand, a zero_run_length_level_equal_two value equal to 1 may indicate that the zero-run length level is two.

A zero_run_length_level_minus3_div2 syntax element may indicate the value of the zero-run length level minus three divided by two. When not present in the bitstream, decoder 201 may infer that the value of the zero_run_length_level_minus3_div2 syntax element is equal to 0. The variable zero_run_length_level may be calculated according to expression (4).

$$zero\_run \_length \_level = zero\_run \text{} \_length \text{} \_level \text{} \_equal \text{} \_zero ? 0 \text{} : ( zero\_run \text{} \_length \text{} \_level \text{} \_equal \text{} \_one ? 1 \text{} : ( zero\_run \text{} \_length \text{} \_level \text{} \_equal \text{} \_two ? 2 \text{} : ( 3 + zero\_run \_length \text{} \_level \text{} \_minus 3 \_partity + ( zero\_run \_length \_level \_minus 3 \_div 2 << 1 ) ) ) ) . \qquad ( 4 )$$

$$The value of zero ‐ run\_length may be calculated according to expression ( 5 ) .$$

$$zero\_run \_length = useGolomb ? ( 2 * zero\_run \_length \_level + zero\_run \_length \_LSB ) \text{} : zero\_run \_length \_level . \qquad ( 5 )$$

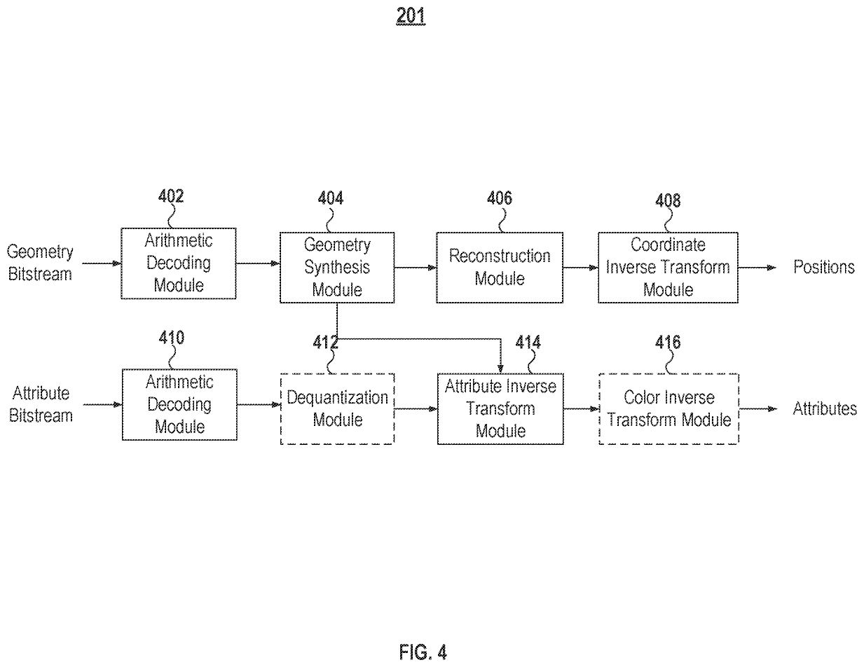

FIG. 4 illustrates a detailed block diagram of exemplary decoder 201 in decoding system 200 in FIG. 2, according to some embodiments of the present disclosure. As shown in FIG. 4, decoder 201 may include an arithmetic decoding module 402, a geometry synthesis module 404, a reconstruction module 406, and a coordinate inverse transform module 408, together configured to decode positions associated with points of a point cloud from the geometry bitstream (i.e., geometry decoding). As shown in FIG. 4, decoder 201 may also include an arithmetic decoding module 410, a dequantization module 412, an attribute inverse transform module 414, and a color inverse transform module 416, together configured to decode attributes associated with points of a point cloud from the attribute bitstream (i.e., attribute decoding). It is understood that each of the elements shown in FIG. 4 is independently shown to represent characteristic functions different from each other in a point cloud decoder, and it does not mean that each component is formed by the configuration unit of separate hardware or single software. That is, each element is included to be listed as an element for convenience of explanation, and at least two of the elements may be combined to form a single element, or one element may be divided into a plurality of elements to perform a function. It is also understood that some of the elements are not necessary elements that perform functions described in the present disclosure but instead may be optional elements for improving performance. It is further understood that these elements may be implemented using electronic hardware, firmware, computer software, or any combination thereof. Whether such elements are implemented as hardware, firmware, or software depends upon the particular application and design constraints imposed on decoder 201. It is still further understood that the modules shown in FIG. 4 are for illustrative purposes only, and in some examples, different modules may be included in decoder 201 for point cloud decoding.

When a point cloud bitstream (e.g., a geometry bitstream or an attribute bitstream) is input from a point cloud encoder (e.g., encoder 101), the input bitstream may be decoded by decoder 201 in a procedure opposite to that of the point cloud encoder. Thus, the details of decoding that are described above with respect to encoding may be skipped for ease of description. Arithmetic decoding modules 402 and 410 may be configured to decode the geometry bitstream and attribute bitstream, respectively, to obtain various information encoded into the bitstream. For example, arithmetic decoding module 410 may decode the attribute bitstream to obtain the attribute information associated with each point, such as the quantization levels or the coefficients of the attributes associated with each point. Optionally, dequantization module 412 may be configured to dequantize the quantization levels of attributes associated with each point to obtain the coefficients of attributes associated with each point. Besides the attribute information, arithmetic decoding module 410 may parse the bitstream to obtain various other information (e.g., in the form of syntax elements), such as the syntax element indicative of the order followed by the points in the 1D array for attribute coding.

Attribute inverse transform module 414 may be configured to perform inverse attribute transformation, such as inverse RAHT, inverse predicting transform, or inverse lifting transform, to transform the data from the transform domain (e.g., coefficients) back to the attribute domain (e.g., luma and/or chroma information for color attributes). Optionally, color inverse transform module 416 may be configured to convert YCbCr color attributes to RGB color attributes.

As to the geometry decoding, geometry synthesis module 404, reconstruction module 406, and coordinate inverse transform module 408 of decoder 201 may be configured to perform the inverse operations of geometry analysis module 306, voxelization module 304, and coordinate transform module 302 of encoder 101, respectively.

Consistent with the scope of the present disclosure, encoder 101 and decoder 201 may be configured to adopt various novel schemes of syntax element representation and organization, as disclosed herein, to improve the flexibility and generality of point cloud coding.

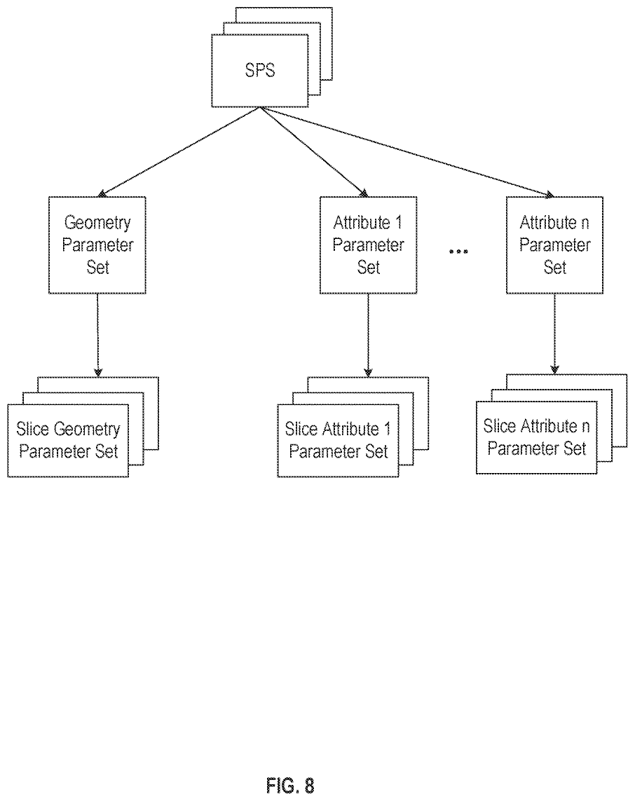

According to some aspects of the present disclosure, various attribute-presence syntax elements are introduced at different levels to control the enablement/disablement of all attributes or an individual attribute in point cloud coding. In some embodiments, the different parameters under the same condition check at the same level (e.g., associated with the same attribute) can be grouped altogether to reduce the number of condition checks, thereby further simplifying the scheme. FIG. 8 illustrates an exemplary hierarchy of parameter sets of G-PCC, according to some embodiments of the present disclosure. A point cloud may be represented in a 1D array including a set of points each associated with a property, such as geometry and attributes (e.g., color and reflectance). The set of points associated with different time stamps may be viewed as a “sequence.”

As shown in FIG. 8, the syntax elements (e.g., parameters, flags, etc.) used for coding the headers of the point cloud may be organized in a hierarchy having various levels. At the top level, the hierarchy may include a sequence header, for example, a header of a sequence parameter set (SPS) associated with the sequence representing the point cloud. At the second level, the hierarchy may include one or more property headers belonging to the sequence header, such as a geometry parameter header and one or more attribute parameter headers. In some embodiments, geometry parameter headers, and attribute parameter headers can also be at the same level as SPS. For example, as shown in FIG. 8, the next level under the SPS may include one header of a geometry parameter set belonging to the SPS and associated with the geometry, as well as one or more headers (1 to n) of attribute parameter sets belonging to the SPS and each associate with a respective attribute (e.g., color or reflectance). At the third level, the hierarchy may include one or more slice property headers belonging to each property header, such as slice geometry parameter headers and slice attribute parameter headers. That is, the sequence representing the point cloud may be divided into one or more slices each including a slice of points, and each slice of points may be associated with one or more slice property headers. For example, as shown in FIG. 8, the next level under the geometry parameter set may include one or more headers of slice geometry parameter sets each belonging to the geometry parameter set and associated with a respective slice of points. Similarly, the next level under each attribute parameter set may include one or more headers of slice attribute parameter sets each belonging to the respective attribute parameter set and associated with a respective slice of points. It is understood that in some examples, the hierarchy may include fewer or more levels, such as picture/frame level(s).

As previously mentioned, to reduce the memory usage, a predefined number may be specified to limit the number of neighboring points that can be used in generating the prediction, as shown in FIG. 7. For prediction, one or more previously coded neighboring points may be used to predict the current point. After the neighboring points are coded, this attribute information (e.g., color value, reflectance value, depth value, etc.) may be maintained in a data buffer (e.g., memory bins) at encoder 101 and decoder 201. The compressed attribute information value(s) (e.g., color value, reflectance value, depth value, etc.) are stored in the data buffer and used for the prediction of other points. The compressed attribute information value(s) may be referred to as “transform coefficients.” To limit the size of the data buffer used to maintain the attribute information value(s) used for prediction, the present disclosure limits the maximum number of transform coefficients (maxNumofCoeff) that are stored for prediction.

According to some aspects consistent with the present disclosure, the maxNumofCoeff may be specified to control the maximum buffer size and to constrain the maximum number of transform coefficients stored in the buffer for prediction. In addition, another parameter, coeffLengthControl is specified to limit the maximum allowed delay, which is defined as maxNumofCoeff*coeffLengthControl. Both parameters are coded with ue(v), which is 0-order exponential-Golomb (EG) coding specified in Table 5 to code the given integer v, where x0, x1, . . . , xn are binary numbers.

TABLE 5
5 k-th order EG

| | | The value |
|---|---|---|
| Order | Code word | represented |
| k = 0 | 1 | 0 |
| | 0 1 x₀ | 1~2 |
| | 0 0 1 x₁ x₀ | 3~6 |
| | 0 0 0 1 x₂ x₁ x₀ | 7~14 |
| | . . . | . . . |
| k = 1 | 1 x₀ | 0~1 |
| | 0 1 x₁ x₀ | 2~5 |
| | 0 0 1 x₂ x₁ x₀ | 6~13 |
| | 0 0 0 1 x₃ x₂ x₁ x₀ | 14~29 |
| | . . . | . . . |
| k = 2 | 1 x₁ x₀ | 0~3 |
| | 0 1 x₂ x₁ x₀ | 4~11 |
| | 0 0 1 x₃ x₂ x₁ x₀ | 12~27 |
| | 0 0 0 1 x₄ x₃ x₂ x₁ x₀ | 28~59 |
| | . . . | . . . |
| k = 3 | 1 x₂ x₁ x₀ | 0~7 |
| | 0 1 x₃ x₂ x₁ x₀ | 8~23 |
| | 0 0 1 x₄ x₃ x₂ x₁ x₀ | 24~55 |
| | 0 0 0 1 x₅ x₄ x₃ x₂ x₁ x₀ | 56~119 |
| | . . . | . . . |

Conventionally, maxNumofCoeff is an unconstrained integer number raised to the second power. Thus, an undesirable amount of memory may be occupied to maintain the transform coefficients used for prediction using existing techniques. To limit the amount of memory storage used for attribute information value storage, encoder 101 may encode the maxNumofCoeff with a Logarithmic format instead of directly coding its decimal value. More specifically, log 2maxNumofCoeffMinusX may be coded in the bitstream with ue (v) format where X is an integer number. The maxNumofCoeff could be calculated as follows: maxNumofCoeff=1<< (log 2maxNumofCoeffMinusX+X). Correspondingly, decoder 201 may calculate maxNumofCoeff by decoding maxNumofCoeffMinusX based on the Logarithmic format. For example, if the maxNumofCoeff is equal to Y, decoder 201 may calculate Y=<< (log 2YMinusX+X).

When X is 8, log 2maxNumofCoeffMinus8 will be coded, and the maxNumofCoeff may be calculated by encoder 101 and decoder 201 as follows: maxNumofCoeff=1<<(log 2maxNumofCoeffMinus8+8). To that end, the present disclosure proposes an exemplary log 2maxNumofCoeffiMinusX syntax element, which is decoded from the bitstream by decoder 201. By way of example and not limitation, X may be an integer number between 0 and 16. The exemplary syntax change to the attribute header is illustrated below in Table 6.

TABLE 6
Syntax change to attribute header

| | |
|---|---|
| If (transform && | |
| ( attributePresentFlag[0] ∥ attributePresentFlag[1]) ) { | |
| log2maxNumofCoeffMinus8 | ue(v) |
| [symbol] | [symbol] |
| coeffLengthControl | ue(v) |

By encoding the maximum number of transform coefficients (e.g., maxNumofCoeffMinusX) by log 2, the number of bits used to communicate this information to decoder 201 may be significantly reduced, as compared with existing techniques. Once the maxNumofCoff is identified, decoder 201 may decode the bitstream to generate an enhanced image, frame, and/or video.

As mentioned above, an attribute residual may be binarized in a format with a zero-run length followed by a non-zero residual value. Encoder 101 may encode the zero-run length and the non-zero residual value into the bitstream using context-adaptive binary arithmetic coding (CABAC), for example. After quantization the attribute information value may be zero. If the current point is zero, the next point may also be zero, and so on. According to some aspects consistent with the present disclosure, instead of coding multiple zeros, encoder 101 may compress the point cloud using zero-run length coding to represent the number of consecutive zeros in the zero-run length rather than encoding the number of consecutive zero points. In some embodiments, the value of zero-run length may be limited so that it is friendly for hardware implementations.

There are two branches for zero-run length coding depending on whether the k-th order EG codeword is smaller than a predefined threshold. The value of zero-run length represented by one branch (e.g., the first branch) may be half of the value represented by another branch (e.g., the second branch). The zero-run length of the first branch may be coded using the following exemplary technique.

For example, a first bin is coded to indicate whether the value of zero-run-length is zero; if it is not zero, the second bin is coded to indicate whether the value of zero-run-length is one; if it is not one, the third bin is coded to indicate whether the value of zero-run-length is two; if it is not two, a parity flag will be coded to indicate whether the value of the zero-run-length minus three is an odd or even number.

After these four flags, a remainder that represents the value of (zero-run-length−3)/2 may be coded. This remainder may be coded with a 2nd order EG codeword. If the maximum number of bins supported by the hardware (e.g., at encoder 101 and/or decoder 201) is N, the maximum value for a 2^{nd}-order EG codeword may be expressed as 1<<((N−1)>>1+1). For example, if N is 32, the maximum value for the remainder will be 1<<((32−1)>>1+1), which is equal to 65536.

Because the value of zero-run-length is coded with a parity value, the maximum value represented could be 131075, which is 65536*2+3. Therefore, the present disclosure proposes that the maximum value of zero-run length (maximum_zero_run_length) may be set as 131075 and 262150 for the first and the second branches for AVS-GPCC, respectively.

Alternatively, the allowed maximum zero-run-length value may be set as any value smaller than 131075, e.g., 131072 for the first branch. The allowed maximum value of zero-run-length for the second branch is two times the allowed maximum value of the first branch. For example, the maximum value could be set as a fixed number or coded in the bitstream, either in the SPS or an attribute header. Additionally and/or alternatively, the allowed maximum value of zero-run-length may be set as 131072 for all cases.

For transform-based GPCC coding, there may be two parameters, e.g., maxNumofCoeff and coeffLengthControl, which are used to control the maximum delay. The maximum delay (Nc) is specified as follows: Nc=maxNumofCoeff*coeffLengthControl. This maximum delay also imposes the maximum zero-run length value allowed for such applications. Therefore, the present disclosure proposes that the allowed Nc may be smaller than the allowed maximum_zero_run_length.

In addition, the coding of the zero-run length may be implemented with multiple callings of the zero_run_length_code(useGolomb) syntax element, depending on the value of the zero-run length. If the return value of zero_run_length_code(useGolomb) is equal to the allowed maximum value, zero_run_length_code(useGolomb) may be coded again until the return value of zero_run_length_code(useGolomb) is smaller than the allowed maximum value. The modified syntax table is shown in Table 7.

TABLE 7
Syntax elements for residual_zero_run_length coding

```

[symbol]

  residual_zero_run_length = 0
  do{
    zero_run_length = zero_run_length_code(useGolomb)
    residual_zero_run_length += zero_run_length
  while(zero_run_length == MAXIMUM_VALUE)
.......
```

The residual_zero_run_length is the zero-run length for attribute coding, zero_run_length is the return value of function zero_run_length_code (useGolomb), MAXIMUM_VALUE are 131075 and 262150 for the first and the second branches in the zero_run_length_code (useGolomb) if maxNumofCoeff and coeffLengthControl are not present in the bitstream, respectively, or MAXIMUM_VALUE is just set as 131072. The MAXIMUM_VALUE is equal to Nc if maxNumofCoeff and coeffLengthControl are present in the bitstream. By way of example and not limitation, assume the MAXIMUM_VALUE for the zero-run length is 131072, and the zero-run length is 655360. When this happens, the zero-run length is coded five separate times (e.g., a multi-loop process) using the syntax elements of Table 7 to indicate the zero-run length is 655360.

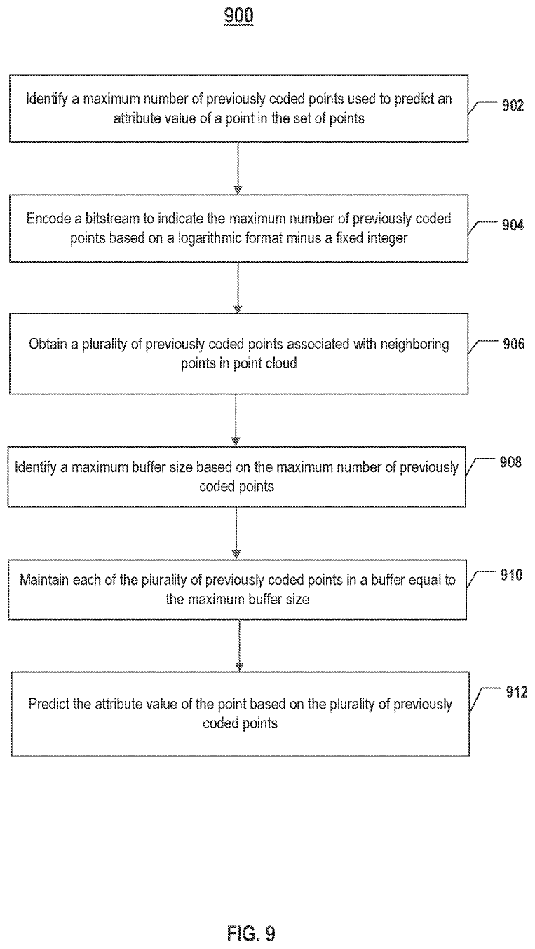

FIG. 9 illustrates a flow chart of an exemplary method 900 of point cloud encoding, according to some embodiments of the present disclosure. Method 900 may be performed by encoder 101 of encoding system 100 or any other suitable point cloud encoding systems. Method 900 may include operations 902-912, as described below. It is understood that some of the operations may be optional, and some of the operations may be performed simultaneously, or in a different order than shown in FIG. 9.

In a first clause, the present disclosure provides a system for decoding a point cloud. The point cloud is represented in a one-dimension (1D) array including a set of points, the system includes:
at least one processor; and
memory storing instructions, which when executed by the at least one processor, cause the at least one processor to:
identify a maximum number of transform coefficients used to predict an attribute value of a point in the set of points; and
decode a bitstream to identify the maximum number of transform coefficients based on a logarithmic format minus a fixed integer.

In a second clause, according to the first clause, the memory storing instructions, which when executed by the at least one processor, further cause the at least one processor to:
obtain a plurality of transform coefficients associated with neighboring points in point cloud,
where a number of transform coefficients in the plurality of transform coefficients is equal to the maximum number of transform coefficients.

In a third clause, according to the second clause, the memory storing instructions, which when executed by the at least one processor, further cause the at least one processor to:
identify a maximum buffer size based on the maximum number of transform coefficients; and
maintain each of the plurality of transform coefficients in a buffer equal to the maximum buffer size.

In a fourth clause, according to the second clause, the memory storing instructions, which when executed by the at least one processor, further cause the at least one processor to:
predict the attribute value of the point based on the plurality of transform coefficients.

In a fifth clause, according to the first clause, the maximum number of transform coefficients is identified based on 1<<(log 2YminusX+X), where Y is the maximum number of transform coefficients as indicated in the bitstream using a log 2YminusX syntax element.

In a sixth clause, the present disclosure provides a system for encoding a point cloud. The point cloud is represented in a one-dimension (1D) array including a set of points, and the system includes:
at least one processor; and
memory storing instructions, which when executed by the at least one processor, cause the at least one processor to:
identify a maximum number of transform coefficients used to predict an attribute value of a point in the set of points; and
encode a bitstream to indicate the maximum number of transform coefficients based on a logarithmic format minus a fixed integer.

In a seventh clause, according to the sixth clause, the memory storing instructions, which when executed by the at least one processor, further cause the at least one processor to:
generate a plurality of transform coefficients associated with neighboring points in point cloud,
where a number of transform coefficients in the plurality of transform coefficients is equal to the maximum number of transform coefficients.

In an eighth clause, according to the seventh clause, the memory storing instructions, which when executed by the at least one processor, further cause the at least one processor to:
identify a maximum buffer size based on the maximum number of transform coefficients; and
maintain each of the plurality of transform coefficients in a buffer equal to the maximum buffer size.

In a ninth clause, according to the seventh clause, the memory storing instructions, which when executed by the at least one processor, further cause the at least one processor to:
predict the attribute value of the point based on the plurality of transform coefficients.

In a tenth clause, according to sixth clause, the maximum number of transform coefficients is identified based on 1<< (log 2YminusX+X), where Y is the maximum number of transform coefficients as indicated in the bitstream using a log 2YminusX syntax element.

In an eleventh clause, the present disclosure provides a system for decoding a point cloud. The point cloud is represented in a one-dimension (1D) array including a set of points, and the system includes:
at least one processor; and
memory storing instructions, which when executed by the at least one processor, cause the at least one processor to:
identify a maximum zero-run length associated with a plurality of attribute values associated with one or more points in the set of points;
in response to a coded zero-run length being less than or equal to the maximum zero-run length, decode a bitstream in a single-loop process based on the zero-run length; and
in response to the coded zero-run length being greater than the maximum zero-run length, decode the bitstream based on the maximum zero-run length and the coded zero-run length in a multi-loop process.

In a twelfth clause, according to the eleventh clause, to identify the maximum zero-run length associated with the plurality of attribute values associated with the one or more points in the set of points, the memory storing instructions, which when executed by the at least one processor, cause the at least one processor to:
in response to the bitstream being transform-encoded, identify the maximum zero-run length as a maximum delay (Nc) indicated in the bitstream; and
in response to the bitstream not being transform-encoded, identify the maximum zero-run length as a predetermined value.

In a thirteenth clause, according to the twelfth clause, Nc is calculated as the maximum number of transform coefficients (maxNumofCoeff) syntax element multiplied by a coefficient length control (CoeffLengthControl) syntax element coded in the bitstream.

In a fourteenth clause, the present disclosure provides a system for encoding a point cloud. The point cloud is represented in a one-dimension (1D) array including a set of points, and the system includes:
at least one processor; and
memory storing instructions, which when executed by the at least one processor, cause the at least one processor to:
identify a maximum zero-run length associated with a plurality of attribute values associated with one or more points in the set of points;
in response to a coded zero-run length being less than or equal to the maximum zero-run length, encode a bitstream in a single-loop process based on the zero-run length; and
in response to the coded zero-run length being greater than the maximum zero-run length, encode bitstream based on the maximum zero-run length and the zero-run length in a multi-loop process.

In a fifteenth clause, according to the fourteenth clause, to identify the maximum zero-run length associated with the plurality of attribute values associated with the one or more points in the set of points, the memory storing instructions, which when executed by the at least one processor, cause the at least one processor to:
in response to the bitstream being transform-encoded, identify the maximum zero-run length as a maximum delay (Nc) indicated in the bitstream; and
in response to the bitstream not being transform-encoded, identify the maximum zero-run length as a predetermined value.

In a sixteenth clause, according to the fifteenth clause, Nc is calculated as the maximum number of transform coefficients (maxNumofCoeff) syntax element multiplied by a coefficient length control (CoeffLengthControl) syntax element.

In a seventeenth clause, the present disclosure provides a method for encoding a point cloud. The point cloud is represented in a one-dimension (1D) array including a set of points, and the method includes:
identifying, by at least one processor, a maximum zero-run length associated with a plurality of attribute values associated with one or more points in the set of points;
in response to a coded zero-run length being less than or equal to the maximum zero-run length, encoding, by the at least one processor, a bitstream in a single-loop process based on the zero-run length; and
in response to the coded zero-run length being greater than the maximum zero-run length, encoding, by the at least one processor, the bitstream based on the maximum zero-run length and the coded zero-run length in a multi-loop process.

In an eighteenth clause, according to the seventeenth clause, the identifying, by the at least one processor, the maximum zero-run length associated with the plurality of attribute values associated with the one or more points in the set of points includes:
in response to the bitstream being transform-encoded, identifying the maximum zero-run length as a maximum delay (Nc) indicated in the bitstream; and
in response to the bitstream not being transform-encoded, identifying the maximum zero-run length as a predetermined value.

In a nineteenth clause, according to the eighteenth clause, Nc is calculated as the maximum number of transform coefficients (maxNumofCoeff) syntax element multiplied by a coefficient length control (CoeffLengthControl) syntax element.

At 902, the encoder may identify a maximum number of transform coefficients used to predict an attribute value of a point in the set of points. For example, to limit the amount of memory storage used for attribute information value storage, encoder 101 may encode the maxNumofCoeff with a Logarithmic format instead of directly coding its decimal value. More specifically, log 2maxNumofCoeffMinusX may be coded in the bitstream with ue (v) format where X is an integer number. The maxNumofCoeff could be calculated as follows: maxNumofCoeff=1<<(log 2maxNumofCoeffMinusX+X). Correspondingly, decoder 201 may calculate max NumofCoeff by decoding maxNumofCoeffMinusX based on the Logarithmic format. For example, when X is 8, log 2maxNumofCoeffMinus8 will be coded, and the maxNumofCoeff may be calculated by encoder 101 and decoder 201 as follows: maxNumofCoeff=1<<(log 2maxNumofCoeffMinus8+8). To that end, the present disclosure proposes an exemplary log 2maxNumofCoeffiMinusX syntax element, which is decoded from the bitstream by decoder 201. By way of example and not limitation, X may be an integer number between 0 and 16. The exemplary syntax change to the attribute header is illustrated above in Table 6.

At 904, the encoder may encode a bitstream to indicate the maximum number of transform coefficients based on a logarithmic format. For example, once the maxNumofCoff is identified, encoder 101 may encode the bitstream to generate an enhanced image, frame, and/or video.

At 906, the encoder may obtain a plurality of transform coefficients associated with neighboring points in the point cloud. For example, to reduce the memory usage, a predefined number may be specified to limit the number of neighboring points that can be used in generating the prediction, as shown in FIG. 7. For prediction, one or more previously coded neighboring points may be used to predict the current point. After the neighboring points are obtained from the bitstream, this attribute information (e.g., color value, reflectance value, depth value, etc.) may be maintained in a data buffer (e.g., memory bins) at encoder 101 and decoder 201. The compressed attribute information value(s) (e.g., color value, reflectance value, depth value, etc.) are stored in the data buffer and used for the prediction of other points. The compressed attribute information value(s) may be referred to as “transform coefficients.” To limit the size of the data buffer used to maintain the attribute information value(s) used for prediction, the present disclosure limits the maximum number of transform coefficients (maxNumofCoeff) that are stored for prediction.

At 908, the encoder may identify a maximum buffer size based on the maximum number of transform coefficients. For example, the maximum buffer size may be identified based on the maximum number of transform coefficients (e.g., one buffer bin per transform coefficient).

At 910, the encoder may maintain each of the plurality of transform coefficients in a buffer equal to the maximum buffer size. For example, each transform coefficient may be maintained in a different buffer bin.

At 912, the encoder may predict the attribute value of the point based on the plurality of transform coefficients. For example, a prediction of the attribute value of a point may be identified based on the transform coefficients maintained in the buffer.

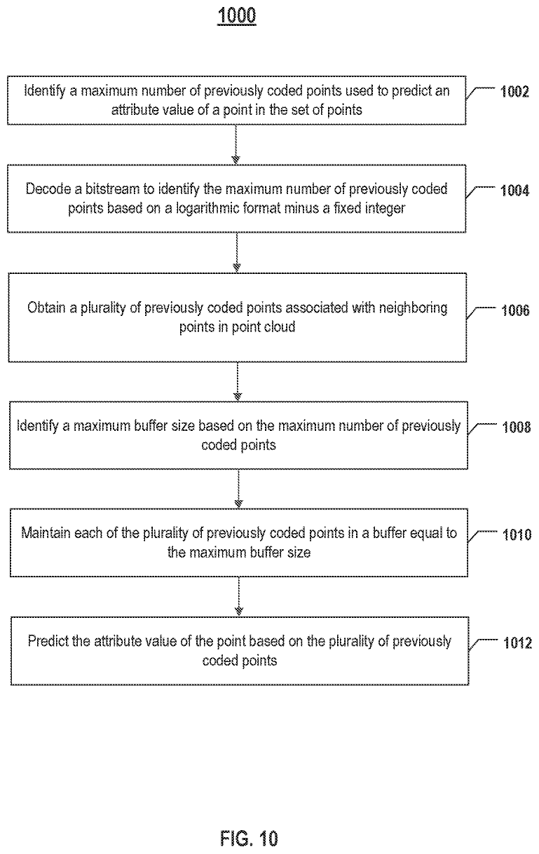

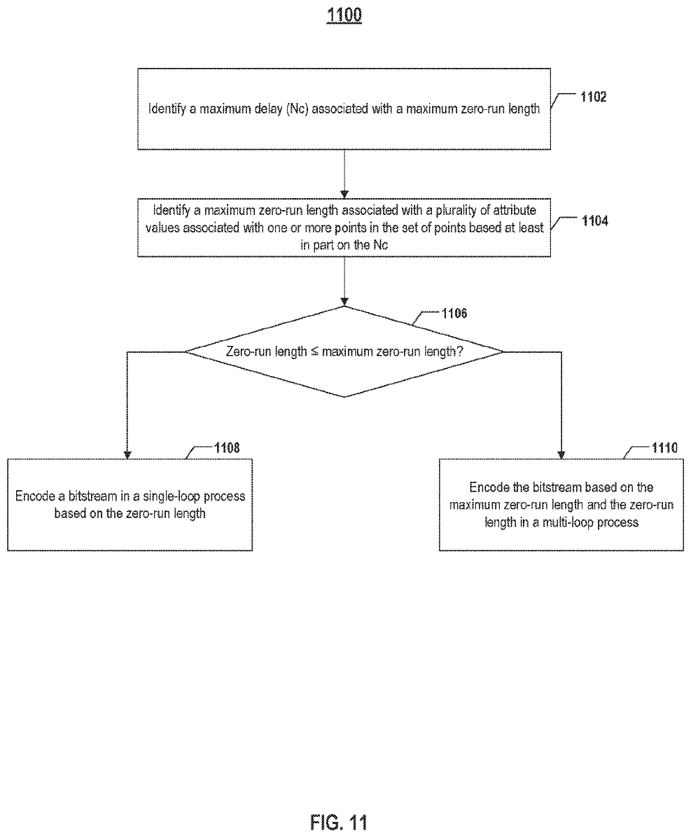

FIG. 10 illustrates a flow chart of an exemplary method 1000 of point cloud decoding, according to some embodiments of the present disclosure. Method 1000 may be performed by decoder 201 of decoding system 200 or any other suitable point cloud encoding systems. Method 1000 may include operations 1002-1012 as described below. It is understood that some of the operations may be optional, and some of the operations may be performed simultaneously, or in a different order than shown in FIG. 10.

At 1002, the decoder may identify a maximum number of transform coefficients used to predict an attribute value of a point in the set of points. For example, to limit the size of the data buffer used to maintain the attribute information value(s) used for prediction, the present disclosure limits the maximum number of transform coefficients (maxNumofCoeff) that are stored for prediction. According to some aspects consistent with the present disclosure, the maxNumofCoeff may be specified to control the maximum buffer size and to constrain the maximum number of transform coefficients stored in the buffer for prediction. In addition, another parameter, coeffLengthControl is specified to limit the maximum allowed delay, which is defined as maxNumofCoeff*coeffLengthControl. Both parameters are coded with ue(v), which is 0-order EG coding specified in Table 5 to code the given integer v, where x0, x1, . . . , xn are binary numbers. For example, when X is 8, log 2maxNumofCoeffMinus8 will be coded, and the maxNumofCoeff may be calculated by encoder 101 and decoder 201 as follows: maxNumofCoeff=1<< (log 2maxNumofCoeffMinus8+8).

To that end, the present disclosure proposes an exemplary log 2maxNumofCoeffiMinusX syntax element, which is decoded from the bitstream by decoder 201. By way of example and not limitation, X may be an integer number between 0 and 16. The exemplary syntax change to the attribute header is illustrated above in Table 6.

At 1004, the decoder may decode a bitstream to identify the maximum number of transform coefficients based on a logarithmic format. For example, once the maxNumofCoff is identified, decoder 201 may decode the bitstream to generate an enhanced image, frame, and/or video.

At 1006, the decoder may obtain a plurality of transform coefficients associated with neighboring points in the point cloud. For example, to reduce the memory usage, a predefined number may be specified to limit the number of neighboring points that can be used in generating the prediction, as shown in FIG. 7. For prediction, one or more previously coded neighboring points may be used to predict the current point. After the neighboring points are obtained from the bitstream, this attribute information (e.g., color value, reflectance value, depth value, etc.) may be maintained in a data buffer (e.g., memory bins) at encoder 101 and decoder 201. The compressed attribute information value(s) (e.g., color value, reflectance value, depth value, etc.) are stored in the data buffer and used for the prediction of other points. The compressed attribute information value(s) may be referred to as “transform coefficients.” To limit the size of the data buffer used to maintain the attribute information value(s) used for prediction, the present disclosure limits the maximum number of transform coefficients (e.g., maxNumofCoeff, Y, etc.) that are stored for prediction.

At 1008, the decoder may identify a maximum buffer size based on the maximum number of transform coefficients. For example, the maximum buffer size may be identified based on the maximum number of transform coefficients (e.g., one buffer bin per transform coefficient).

At 1010, the decoder may maintain each of the plurality of transform coefficients in a buffer equal to the maximum buffer size. For example, each transform coefficient may be maintained in a different buffer bin.

At 1012, the decoder may predict the attribute value of the point based on the plurality of transform coefficients. For example, a prediction of the attribute value of a point may be generated based on the transform coefficients maintained in the buffer.

FIG. 11 illustrates a flow chart of an exemplary method 1100 of point cloud encoding, according to some embodiments of the present disclosure. Method 1100 may be performed by encoder 101 of encoding system 100 or any other suitable point cloud decoding systems. Method 1100 may include operations 1102-1108 as described below. It is understood that some of the operations may be optional.

At 1102, the encoder may identify a maximum delay (Nc) associated with a maximum zero-run length. In some embodiments, the maximum delay may be less than the maximum zero-run length. For example, for transform-based GPCC coding, there may be two parameters, e.g., maxNumofCoeff and coeffLengthControl, which are used to control the maximum delay. The maximum delay (Nc) is specified as follows: Nc=maxNumofCoeff*coeffLengthControl. This maximum delay also imposes the maximum zero-run length value allowed for such applications. Therefore, the present disclosure proposes that the allowed Nc may be smaller than the allowed maximum_zero_run_length.

At 1104, the encoder may identify a maximum zero-run length associated with a plurality of attribute values associated with one or more points in the set of points. In some embodiments, the maximum zero-run length may be identified based at least in part on Nc. In some embodiments, the identifying the maximum zero-run length associated with the plurality of attribute values associated with the one or more points in the set of points may include decoding a first flag from the bitstream to determine whether a zero-run length is zero. In some embodiments, the identifying the maximum zero-run length associated with the plurality of attribute values associated with the one or more points in the set of points may include, in response to determining that the zero-run length is not zero, decoding a second flag from the bitstream to determine whether the zero-run length is one. In some embodiments, the identifying the maximum zero-run length associated with the plurality of attribute values associated with the one or more points in the set of points may include, in response to determining that the zero-run length is not one, decoding a third flag from the bitstream to determine whether the zero-run length is two. In some embodiments, the identifying the maximum zero-run length associated with the plurality of attribute values associated with the one or more points in the set of points may include, in response to determining that the zero-run length is not two, decoding a fourth flag from the bitstream to determine whether a value of the zero-run length minus three is odd or even. In some embodiments, the identifying the maximum zero-run length associated with the plurality of attribute values associated with the one or more points in the set of points may include decoding the remainder of the zero-run length from the bitstream. In some embodiments, the remainder of the zero-run length may include the value of the zero-run length minus three divided by two. For example, there are two branches for zero-run length coding depending on whether the k-th order EG codeword is smaller than a predefined threshold. The value of zero-run length represented by one branch (e.g., the first branch) may be half of the value represented by another branch (e.g., the second branch). The zero-run length of the first branch may be coded using the following exemplary technique. For example, a first bin is encoded to indicate whether the value of zero-run-length is zero; if it is not zero, the second bin is coded to indicate whether the value of zero-run-length is one; if it is not one, the third bin is coded to indicate whether the value of zero-run-length is two; if it is not two, a parity flag will be coded to indicate whether the value of the zero-run-length minus three is an odd or even number. After these four flags, a remainder that represents the value of (zero-run-length−3)/2 may be decoded. This remainder may be coded with a 2nd-order EG codeword. If the maximum number of bins supported by the hardware (e.g., at encoder 101 and/or decoder 201) is N, the maximum value for a 2nd-order EG codeword may be expressed as 1<<((N−1)>>1+1). For example, if N is 32, the maximum value for the remainder will be 1<<((32−1)>>1+1), which is equal to 65536. By decoding these syntax elements encoded by encoder 101, decoder 201 may identify the maximum zero-run length.

At 1106, the encoder may determine whether the zero-run length is less than or equal to the maximum zero-run length. This determination may be made by comparing the zero-run length with the maximum zero-run length. If “YES” at 1106, the operations may move to 1108; otherwise, if “NO” at 1106, the operations may move to 1110.

At 1108, the encoder may encode the bitstream in a single-loop process based on the zero-run length. By way of example and not limitation, assume the MAXIMUM_VALUE for the zero-run length is 131072, and the zero-run length is 131070. When this happens, the zero-run length is encoded once (e.g., a single-loop process) using the syntax elements of Table 7 to indicate the zero-run length is 131070.

At 1110, the encoder may encode the bitstream in a multi-loop process based on the maximum zero-run length and the zero-run length. By way of example and not limitation, assume the MAXIMUM_VALUE for the zero-run length is 131072, and the zero-run length is 655360. When this happens, the zero-run length is encoded five times (e.g., a multi-loop process) using the syntax elements of Table 7 to indicate the zero-run length is 655360.

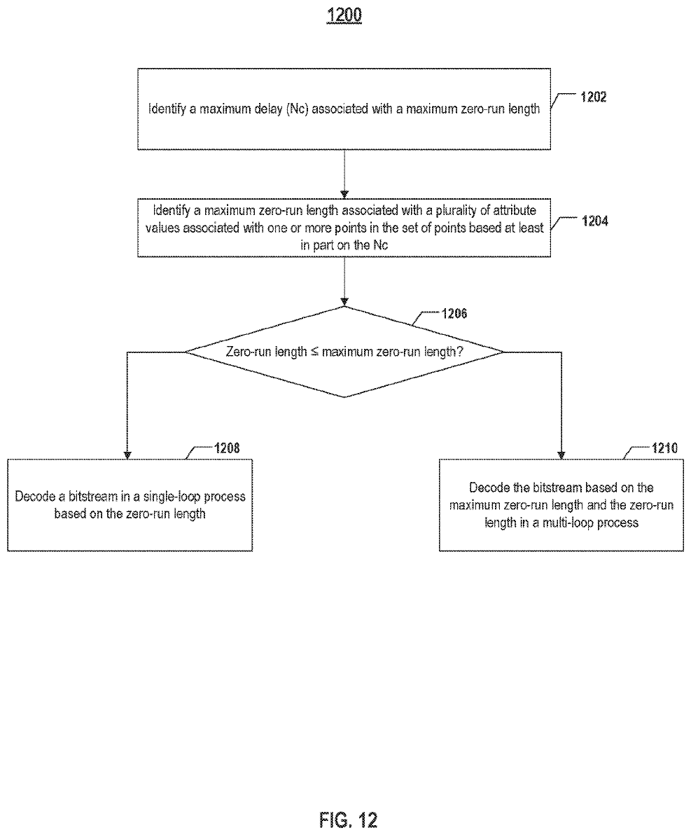

FIG. 12 illustrates a flow chart of an exemplary method 1200 of point cloud decoding, according to some embodiments of the present disclosure. Method 1200 may be performed by decoder 201 of decoding system 200 or any other suitable point cloud decoding systems. Method 1200 may include operations 1202-1210 as described below. It is understood that some of the operations may be optional, and some of the operations may be performed simultaneously, or in a different order other than shown in FIG. 12.

At 1202, the decoder may identify a maximum delay (Nc) associated with a maximum zero-run length. In some embodiments, the maximum delay may be less than the maximum zero-run length. For example, for transform-based GPCC coding, there may be two parameters, e.g., maxNumofCoeff and coeffLengthControl, which are used to control the maximum delay. The maximum delay (Nc) is specified as follows: Nc=maxNumofCoeff*coeffLengthControl. This maximum delay also imposes the maximum zero-run length value allowed for such applications. Therefore, the present disclosure proposes that the allowed Nc may be smaller than the allowed maximum_zero_run_length.

At 1204, the decoder may identify a maximum zero-run length associated with a plurality of attribute values associated with one or more points in the set of points. At 1204, the decoder may identify a maximum zero-run length associated with a plurality of attribute values associated with one or more points in the set of points. In some embodiments, the identifying, by the at least one processor, the maximum zero-run length associated with the plurality of attribute values associated with the one or more points in the set of points may include, in response to the bitstream being transform-encoded, identifying the maximum zero-run length as a Nc indicated in the bitstream. In some embodiments, the identifying, by the at least one processor, the maximum zero-run length associated with the plurality of attribute values associated with the one or more points in the set of points may include, in response to the bitstream not being transform-encoded, identifying the maximum zero-run length as a predetermined value (e.g., 131072). In some embodiments, Nc may be calculated as the maximum number of transform coefficients (maxNumofCoeff) syntax element multiplied by a coefficient length control (CoeffLengthControl) syntax element coded in the bitstream.

At 1206, the decoder may determine whether the zero-run length is less than or equal to the maximum zero-run length. This determination may be made by comparing the zero-run length with the maximum zero-run length. If “YES” at 1206, the operations may move to 1208; otherwise, if “NO” at 1206, the operations may move to 1210.

At 1208, the decoder may decode the bitstream in a single-loop process based on the zero-run length. By way of example and not limitation, assume the MAXIMUM_VALUE for the zero-run length is 131072, and the zero-run length is 131070. When this happens, the zero-run length is decoded once (e.g., a single-loop process) using the syntax elements of Table 7 to identify the zero-run length is 131070.

At 1210, the decoder may encode the bitstream in a multi-loop process based on the maximum zero-run length and the zero-run length. By way of example and not limitation, assume the MAXIMUM_VALUE for the zero-run length is 131072, and the zero-run length is 655360. When this happens, the zero-run length is decoded five times (e.g., a multi-loop process) using the syntax elements of Table 7 to indicate the zero-run length is 655360.

In various aspects of the present disclosure, the functions described herein may be implemented in hardware, software, firmware, or any combination thereof. If implemented in software, the functions may be stored as instructions on a non-transitory computer-readable medium. Computer-readable media includes computer storage media. Storage media may be any available media that can be accessed by a processor, such as processor 102 in FIGS. 1 and 2. By way of example, and not limitation, such computer-readable media can include RAM, ROM, EEPROM, CD-ROM or other optical disk storage, HDD, such as magnetic disk storage or other magnetic storage devices, Flash drive, SSD, or any other medium that can be used to carry or store desired program code in the form of instructions or data structures and that can be accessed by a processing system, such as a mobile device or a computer. Disk and disc, as used herein, includes CD, laser disc, optical disc, digital video disc (DVD), and floppy disk where disks usually reproduce data magnetically, while discs reproduce data optically with lasers. Combinations of the above should also be included within the scope of computer-readable media.

According to one aspect of the present disclosure, a method for decoding a point cloud that is represented in a 1D array that includes a set of points is provided. The method may include identifying, by at least one processor, a maximum number of transform coefficients used to predict an attribute value of a point in the set of points. The method may include decoding, by the at least one processor, a bitstream to identify the maximum number of transform coefficients based on a logarithmic format minus a fixed integer.

In some embodiments, the method may include obtaining, by the at least one processor, a plurality of transform coefficients associated with neighboring points in point cloud. In some embodiments, a number of transform coefficients in the plurality of transform coefficients may be equal to the maximum number of transform coefficients.

In some embodiments, the method may include identifying, by the at least one processor, a maximum buffer size based on the maximum number of transform coefficients. In some embodiments, the method may include maintaining, by the at least one processor, each of the plurality of transform coefficients in a buffer equal to the maximum buffer size.

In some embodiments, the method may include predicting, by the at least one processor, the attribute value of the point based on the plurality of transform coefficients.

In some embodiments, the maximum number of transform coefficients may be identified based on Y=1<<(log 2YminusX+X), where Y is the maximum number of transform coefficients as indicated in the bitstream using a log 2YminusX syntax element.

According to another aspect of the present disclosure, a system for decoding a point cloud that is represented in a 1D array that includes a set of points is provided. The system may include at least one processor and memory storing instructions. The memory storing instructions, which when executed by the at least one processor, may cause the at least one processor to identify a maximum number of transform coefficients used to predict an attribute value of a point in the set of points. The memory storing instructions, which when executed by the at least one processor, may cause the at least one processor to decode a bitstream to identify the maximum number of transform coefficients based on a logarithmic format minus a fixed integer.

In some embodiments, the memory storing instructions, which when executed by the at least one processor, may further cause the at least one processor to obtain a plurality of transform coefficients associated with neighboring points in point cloud. In some embodiments, a number of transform coefficients in the plurality of transform coefficients may be equal to the maximum number of transform coefficients.

In some embodiments, the memory storing instructions, which when executed by the at least one processor, may cause the at least one processor to identify a maximum buffer size based on the maximum number of transform coefficients. The memory storing instructions, which when executed by the at least one processor, may cause the at least one processor to maintain each of the plurality of transform coefficients in a buffer equal to the maximum buffer size.

In some embodiments, the memory storing instructions, which when executed by the at least one processor, may cause the at least one processor to predict the attribute value of the point based on the plurality of transform coefficients.

In some embodiments, the maximum number of transform coefficients may be identified based on Y=1<< (log 2YminusX+X), where Y is the maximum number of transform coefficients as indicated in the bitstream using a log 2YminusX syntax element.

According to a further aspect of the present disclosure, a method for encoding a point cloud that is represented in a 1D array including a set of points is provided. The method may include identifying, by at least one processor, a maximum number of transform coefficients used to predict an attribute value of a point in the set of points. The method may include encoding, by the at least one processor, a bitstream to indicate the maximum number of transform coefficients based on a logarithmic format minus a fixed integer.

In some embodiments, the method may include generating, by the at least one processor, a plurality of transform coefficients associated with neighboring points in point cloud. In some embodiments, a number of transform coefficients in the plurality of transform coefficients may be equal to the maximum number of transform coefficients.

In some embodiments, the method may include identifying, by the at least one processor, a maximum buffer size based on the maximum number of transform coefficients. The method may include maintaining, by the at least one processor, each of the plurality of transform coefficients in a buffer equal to the maximum buffer size.

In some embodiments, the method may include predicting, by the at least one processor, the attribute value of the point based on the plurality of transform coefficients.

In some embodiments, the maximum number of transform coefficients may be indicated in the bitstream using a log 2maxNumofCoeffMinusX syntax element.

According to a further aspect of the present disclosure, a system for encoding a point cloud that is represented in a 1D array including a set of points is provided. The system may include at least one processor and memory storing instructions. The memory storing instructions, which when executed by at least one processor, may cause the at least one processor to identify a maximum number of transform coefficients used to predict an attribute value of a point in the set of points. The memory storing instructions, which when executed by at least one processor, may cause the at least one processor to encode a bitstream to indicate the maximum number of transform coefficients based on a logarithmic format minus a fixed integer.

In some embodiments, the memory storing instructions, which when executed by the at least one processor, may further cause the at least one processor to generate a plurality of transform coefficients associated with neighboring points in point cloud. In some embodiments, a number of transform coefficients in the plurality of transform coefficients may be equal to the maximum number of transform coefficients.

In some embodiments, the memory storing instructions, which when executed by the at least one processor, may further cause the at least one processor to identify a maximum buffer size based on the maximum number of transform coefficients. In some embodiments, the memory storing instructions, which when executed by the at least one processor, may further cause the at least one processor to maintain each of the plurality of transform coefficients in a buffer equal to the maximum buffer size.

In some embodiments, the memory storing instructions, which when executed by the at least one processor, may further cause the at least one processor to predict the attribute value of the point based on the plurality of transform coefficients.

In some embodiments, the maximum number of transform coefficients may be identified based on Y=1<< (log 2YminusX+X), where Y is the maximum number of transform coefficients as indicated in the bitstream using a log 2YminusX syntax element.

According to yet another aspect of the present disclosure, a method for decoding a point cloud that is represented in a 1D array including a set of points is provided. The method may include identifying, by at least one processor, a maximum zero-run length associated with a plurality of attribute values associated with one or more points in the set of points. In response to a coded zero-run length being less than or equal to the maximum zero-run length, the method may include decoding, by the at least one processor, a bitstream in a single-loop process based on the zero-run length. In response to the coded zero-run length being greater than the maximum zero-run length, the method may include decoding, by the at least one processor, the bitstream based on the maximum zero-run length and the coded zero-run length in a multi-loop process.

In some embodiments, the identifying, by the at least one processor, the maximum zero-run length associated with the plurality of attribute values associated with the one or more points in the set of points may include, in response to the bitstream being transform-encoded, identifying the maximum zero-run length as a Nc indicated in the bitstream. In some embodiments, the identifying, by the at least one processor, the maximum zero-run length associated with the plurality of attribute values associated with the one or more points in the set of points may include, in response to the bitstream not being transform-encoded, identifying the maximum zero-run length as a predetermined value.

In some embodiments, Nc may be calculated as the maximum number of transform coefficients (maxNumofCoeff) syntax element multiplied by a coefficient length control (CoeffLengthControl) syntax element coded in the bitstream.

According to yet a further aspect of the present disclosure, a system for decoding a point cloud that is represented in a 1D array including a set of points is provided. The system may include at least one processor and memory storing instructions. The memory storing instructions, which when executed by the at least one processor, may cause the at least one processor to identify a maximum zero-run length associated with a plurality of attribute values associated with one or more points in the set of points. In response to a coded zero-run length being less than or equal to the maximum zero-run length, the memory storing instructions, which when executed by the at least one processor, may cause the at least one processor to decode a bitstream in a single-loop process based on the zero-run length. In response to the coded zero-run length being greater than the maximum zero-run length, the memory storing instructions, which when executed by the at least one processor, may cause the at least one processor to decode the bitstream based on the maximum zero-run length and the coded zero-run length in a multi-loop process.

In some embodiments, to identify the maximum zero-run length associated with the plurality of attribute values associated with the one or more points in the set of points, the memory storing instructions, which when executed by the at least one processor, may cause the at least one processor to, in response to the bitstream being transform-encoded, identify the maximum zero-run length as a Nc indicated in the bitstream; and

In some embodiments, to identify the maximum zero-run length associated with the plurality of attribute values associated with the one or more points in the set of points, the memory storing instructions, which when executed by the at least one processor, may cause the at least one processor to, in response to the bitstream not being transform-encoded, identify the maximum zero-run length as a predetermined value.

In some embodiments, Nc may be calculated as the maximum number of transform coefficients (maxNumofCoeff) syntax element multiplied by a coefficient length control (CoeffLengthControl) syntax element coded in the bitstream.

According to yet a further aspect of the present disclosure, a method for encoding a point cloud that is represented in a 1D array including a set of points is provided. The method may include identifying, by at least one processor, a maximum zero-run length associated with a plurality of attribute values associated with one or more points in the set of points. In response to a coded zero-run length being less than or equal to the maximum zero-run length, the method may include encoding, by the at least one processor, a bitstream in a single-loop process based on the zero-run length. The method further includes: in response to the coded zero-run length being greater than the maximum zero-run length, encoding, by the at least one processor, the bitstream based on the maximum zero-run length and the coded zero-run length in a multi-loop process.

In some embodiments, the identifying, by the at least one processor, the maximum zero-run length associated with the plurality of attribute values associated with the one or more points in the set of points may include, in response to the bitstream being transform-encoded, identifying the maximum zero-run length as a Nc indicated in the bitstream. In some embodiments, the identifying, by the at least one processor, the maximum zero-run length associated with the plurality of attribute values associated with the one or more points in the set of points may include, in response to the bitstream not being transform-encoded, identifying the maximum zero-run length as a predetermined value.

According to still a further aspect of the present disclosure, a system for encoding a point cloud that is represented in a 1D array including a set of points is provided. The system may include at least one processor and memory storing instructions. The memory storing instructions, which when executed by the at least one processor, may cause the at least one processor to identify a maximum zero-run length associated with a plurality of attribute values associated with one or more points in the set of points. In response to a coded zero-run length being less than or equal to the maximum zero-run length, the memory storing instructions, which when executed by the at least one processor, may cause the at least one processor to encode a bitstream in a single-loop process based on the zero-run length. In response to the coded zero-run length being greater than the maximum zero-run length, the memory storing instructions, which when executed by the at least one processor, may cause the at least one processor to encode the bitstream based on the maximum zero-run length and the coded zero-run length in a multi-loop process.

In some embodiments, to identify the maximum zero-run length associated with the plurality of attribute values associated with the one or more points in the set of points, the memory storing instructions, which when executed by the at least one processor, may cause the at least one processor to, in response to the bitstream being transform-encoded, identify the maximum zero-run length as a Nc indicated in the bitstream. In some embodiments, to identify the maximum zero-run length associated with the plurality of attribute values associated with the one or more points in the set of points, the memory storing instructions, which when executed by the at least one processor, may cause the at least one processor to, in response to the bitstream not being transform-encoded, identify the maximum zero-run length as a predetermined value.

In some embodiments, Nc may be calculated as the maximum number of transform coefficients (maxNumofCoeff) syntax element multiplied by a coefficient length control (CoeffLengthControl) syntax element.

The foregoing description of the embodiments will so reveal the general nature of the present disclosure that others can, by applying knowledge within the skill of the art, readily modify and/or adapt for various applications such embodiments, without undue experimentation, without departing from the general concept of the present disclosure. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

Embodiments of the present disclosure have been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The Summary and Abstract sections may set forth one or more but not all exemplary embodiments of the present disclosure as contemplated by the inventor(s), and thus, are not intended to limit the present disclosure and the appended claims in any way.

Various functional blocks, modules, and steps are disclosed above. The arrangements provided are illustrative and without limitation. Accordingly, the functional blocks, modules, and steps may be reordered or combined in different ways than in the examples provided above. Likewise, some embodiments include only a subset of the functional blocks, modules, and steps, and any such subset is permitted.

The breadth and scope of the present disclosure should not be limited by any of the above-described exemplary embodiments, but should be defined only in accordance with the following claims and their equivalents.

1. A method for decoding a point cloud, the point cloud being represented in a one-dimension (1D) array comprising a set of points, the method comprising:
identifying, by at least one processor, a maximum number of transform coefficients used to predict an attribute value of a point in the set of points; and
decoding, by the at least one processor, a bitstream to identify the maximum number of transform coefficients based on a logarithmic format minus a fixed integer.

2. The method of claim 1, further comprising:
obtaining, by the at least one processor, a plurality of transform coefficients associated with neighboring points in point cloud,
wherein a number of transform coefficients in the plurality of transform coefficients is equal to the maximum number of transform coefficients.

3. The method of claim 2, further comprising:
identifying, by the at least one processor, a maximum buffer size based on the maximum number of transform coefficients; and
maintaining, by the at least one processor, each of the plurality of transform coefficients in a buffer equal to the maximum buffer size.

4. The method of claim 2, further comprising:
predicting, by the at least one processor, the attribute value of the point based on the plurality of transform coefficients.

5. The method of claim 1, wherein the maximum number of transform coefficients is identified based on Y=1<< (log 2YminusX+X), where Y is the maximum number of transform coefficients as indicated in the bitstream using a log 2YminusX syntax element.

6-10. (canceled)

11. A method for encoding a point cloud, the point cloud being represented in a one-dimension (1D) array comprising a set of points, the method comprising:
identifying, by at least one processor, a maximum number of transform coefficients used to predict an attribute value of a point in the set of points; and
encoding, by the at least one processor, a bitstream to indicate the maximum number of transform coefficients based on a logarithmic format minus a fixed integer.

12. The method of claim 11, further comprising:
generating, by the at least one processor, a plurality of transform coefficients associated with neighboring points in point cloud,
wherein a number of transform coefficients in the plurality of transform coefficients is equal to the maximum number of transform coefficients.

13. The method of claim 12, further comprising:
identifying, by the at least one processor, a maximum buffer size based on the maximum number of transform coefficients; and
maintaining, by the at least one processor, each of the plurality of transform coefficients in a buffer equal to the maximum buffer size.

14. The method of claim 12, further comprising:
predicting, by the at least one processor, the attribute value of the point based on the plurality of transform coefficients.

15. The method of claim 11, wherein the maximum number of transform coefficients is identified based on 1<< (log 2YminusX+X), where Y is the maximum number of transform coefficients as indicated in the bitstream using a log 2YminusX syntax element.

16-20. (canceled)

21. A method for decoding a point cloud, the point cloud being represented in a one-dimension (1D) array comprising a set of points, the method comprising:
identifying, by at least one processor, a maximum zero-run length associated with a plurality of attribute values associated with one or more points in the set of points;
in response to a coded zero-run length being less than or equal to the maximum zero-run length, decoding, by the at least one processor, a bitstream in a single-loop process based on the zero-run length; and
in response to the coded zero-run length being greater than the maximum zero-run length, decoding, by the at least one processor, the bitstream based on the maximum zero-run length and the coded zero-run length in a multi-loop process.

22. The method of claim 21, wherein the identifying, by the at least one processor, the maximum zero-run length associated with the plurality of attribute values associated with the one or more points in the set of points comprises:
in response to the bitstream being transform-encoded, identifying the maximum zero-run length as a maximum delay (Nc) indicated in the bitstream; and
in response to the bitstream not being transform-encoded, identifying the maximum zero-run length as a predetermined value.

23. The method of claim 22, wherein Nc is calculated as the maximum number of transform coefficients (maxNumofCoeff) syntax element multiplied by a coefficient length control (CoeffLengthControl) syntax element coded in the bitstream.

24-32. (canceled)
